(19) United States
(12) Patent Application Publication
(10) Pub. No.: US 2026/0255417 A1
(43) Pub. Date: Aug. 27, 2026

(54) CONNECTIVITY OF KIND

(71) Applicant: Marc Chelnik, Woodstock, NY (US)

(72) Inventor: Marc Chelnik, Woodstock, NY (US)

(21) Appl. No.: 18/747,427

(22) Filed: Jun. 18, 2024

Related U.S. Application Data
(60) Provisional application No. 63/611,741, filed on Dec. 18, 2023.

(51) Int. Cl. H04W 76/15; H04W 4/029; H04W 56/00; H04W 84/18

(52) U.S. Cl. CPC H04W 76/15; H04W 4/029; H04W 56/0015; H04W 84/18

(57) ABSTRACT

A system and methods for allowing independent electronic devices to communicate with other devices in an intelligent manner. A plurality of independent micro communication devices, each of the plurality of independent micro communication with capability and memory configured to find and associate as to communicate and connect with the plurality of independent micro communication devices as to display a nature of the connection, to be able to exchange data, instructions, record the history of actions and to facilitate learning and introduction. Wherein each of the plurality of independent micro communication devices can be administered in a variety of configurations that are selectable including private (user), regional (group) or master (central control perhaps cloud configuration) or a system of Artificial Intelligence. Wherein each of the plurality of independent micro communication devices is programmed capable to have an identity, wherein the identity is one of assignment, self-propagation or discovery that can be administered in a variety of configurations ranging from solo entities to a confederation of devices to a centrally controlled system, and wherein the administration of the system can vary access to all components of the plurality of independent micro communication devices, selectable by the configuration.

### CROSS-REFERENCE TO RELATED APPLICATION

The present application claims the benefit of U.S. Patent Application No. 63/611,741 for COMMUNICATION SYSTEM FOR COMMONALITY INFORMATION AND INSTRUCTIONS EXCHANGE BETWEEN INDEPENDENT DEVICES, filed Dec. 18, 2023, the entire contents of which are incorporated herein by reference in their entirety.

### FIELD OF THE INVENTION

The present disclosure relates to innovative systems and methodologies designed to connect users and/or devices based on shared information instructions and or commonality, aiming to facilitate information exchange and diverse interactions among these users.

### INTRODUCTION

Various entities including, but not limited to, individuals, groups, organizations, mechanical devices, and cybernetic systems necessarily utilize information sharing protocols. Such sharing of information may be needed to facilitate transmission of instructions, associate a given device with another device, and permit other processes. All such entities benefit by sharing mutual interests, objectives and experiences to best learn and achieve dedicated objectives. The need to communicate and make connections between a range of such entities that share a commonality is universal. Such a need ranges from human interaction to machine and robotic interaction (e.g., those that emulate and perform according to human abilities). The system of the instant description, described below, is a systematic configuration of devices and sets of procedures that facilitate the sharing of information and instructions between entities in a unique interactive manner.

As a nonlimiting example, individuals, groups, organizations, mechanical devices, cybernetic systems and other entities commonly share mutual interests in specific domains like music, geography, history, politics, and education. The inherent desire to communicate, interact, or establish relationships with others who share similar likenesses is a prevailing aspect among such entities.

Moreover, objects, ranging from electro-mechanical machines to virtual reality avatars and IoT devices, can be dynamically programmed to exhibit a “likeness” and dependencies or prescribed procedures for specific subjects. Establishing connections between these objects, mirroring the desires of such entities, proves to be advantageous for networking and enhancing preexisting workflows.

Traditionally, a searching entity or device aiming to find others with shared likenesses conducts subject-related searches within databases. However, this approach has limitations, as it may overlook entities or objects not present in the searched database or not associated with the queried subject. Even when a potential associated information exchange is identified, establishing a relationship can be hindered by the lack of available contact information or disparities in physical or virtual locations.

In response, there is a discernible demand for improved systems and methods capable of effectively identifying and pairing users or devices with mutual common interests, procedural association, and/or prescribed sequencing. An optimal implementation involves adapting these systems to ascertain a commonality between users be it the physical and/or virtual environment of these users or devices, streamlining the process of environmental filtering for matches. Furthermore, these systems should empower users or devices to articulate preferences related to matching parameters and shared information, complemented by a robust notification mechanism for identified matches and connections.

Thus, it would be desirable to provide systems and methods configured to enable meaningful matching and subsequent communication between entities, both human and machine, in either a real-world environment or a digital environment.

### SUMMARY

In accordance with the present disclosure, the following items are provided.

Provided may be a system comprising a plurality of independent micro communication devices, each of the plurality of independent micro communication devices comprising: a signal indicator configured to determine a range of other independent micro communication devices within the plurality of independent micro communication devices; a microprocessor in communication with the signal indicator, the microprocessor configured to emit a beacon signal via a first wireless technology, the microprocessor configured to generate an initial connection between two or more of the plurality of independent micro communication devices, the microprocessor configured to exchange data with the two or more of the plurality of independent micro communication devices substantiating the initial connection via a second wireless technology, wherein the beacon signal and the first wireless technology are configured for transmission of small data packets, wherein, after the initial connection is formed, each of the independent micro communication devices substantiating the initial connection are switched to the second wireless technology, wherein the second wireless technology is configured for transmission of large data packets, wherein the large data packets comprise one or more instructions sets; and an indicator device configured to display a nature of the initial connection.

In an embodiment, each of the plurality of independent micro communication devices are preloaded with preliminary data, wherein the preliminary data is derived from one of: a form completed by an individual, information provided by a central source, or information gathered, via artificial intelligence, from one or more available sources.

In an embodiment, each of the plurality of independent micro communication devices within a predetermined range are configured to communicate with each other to facilitate data transmission, positioning, and robotic control.

In an embodiment, the data transmission between each of the plurality of independent micro communication devices within a predetermined range is stored in a database, and wherein the database is in communication with an artificial intelligence component.

In an embodiment, the nature of the initial connection is displayed on each of the independent micro communication devices substantiating the initial connection, wherein the nature of the initial connection comprises an identity of each of the independent micro communication devices substantiating the initial connection.

In an embodiment, each of the independent micro communication devices substantiating the initial connection are archived with a status of compatibility adapted to promote a direct data exchange, wherein the direct data exchange comprises exchange of at least one of: artificial intelligence-derived information, preprogramed data exchange, or a personal interaction.

In an embodiment, the one or more instructions sets are fixed and preuploaded, or are dynamic and controlled in real-time by a system administrator, or a combination thereof.

In an embodiment, the system comprises a positioning module configured to spatially synchronize and calibrate the plurality of independent micro communication devices in a physical environment.

In an embodiment, the system comprises a positioning module configured to spatially synchronize and calibrate the plurality of independent micro communication devices in a virtual environment.

Provided may be a system comprising a plurality of independent micro communication devices, each of the plurality of independent micro communication devices configured to communicate and connect with the plurality of independent micro communication devices and display a nature of the connection, wherein each of the plurality of independent micro communication devices are controlled by at least one of a central control and a regional control, wherein each of the plurality of independent micro communication devices is programmed with an identity, wherein the identity is one of self-propagated and centrally controlled, and
wherein the central control has access to all components of the plurality of independent micro communication devices.

In an embodiment, each of the plurality of independent micro communication devices are preloaded with preliminary data, wherein the preliminary data is derived from one of: a form completed by an individual, information provided by a central source, or information gathered, via artificial intelligence, from one or more available sources.

In an embodiment, each of the plurality of independent micro communication devices within a predetermined range are configured to communicate with each other to facilitate data transmission, positioning, and robotic control.

In an embodiment, the data transmission between each of the plurality of independent micro communication devices within the predetermined range is stored in a database, and wherein the database is in communication with an artificial intelligence component.

In an embodiment, the nature of the connection is displayed on each of the independent micro communication devices substantiating the connection, wherein the nature of the connection comprises the identity of each of the independent micro communication devices substantiating the connection.

In an embodiment, each of the independent micro communication devices substantiating the initial connection are archived with a status of compatibility adapted to promote a direct data exchange, wherein the direct data exchange comprises exchange of at least one of: artificial intelligence-derived information, preprogramed data exchange, or a personal interaction.

In an embodiment, one of the central control and the regional control curate one or more instructions sets and transmit said instruction sets to the plurality of independent micro communication device, wherein the one or more instructions sets are fixed and preuploaded, or are dynamic and controlled in real-time by a system administrator, or a combination.

In an embodiment, the system comprises a positioning module configured to spatially synchronize and calibrate the plurality of independent micro communication devices in a physical environment.

In an embodiment, the system comprises a positioning module configured spatially synchronize and calibrate the plurality of independent micro communication devices in a virtual environment.

Provided may be a system comprising a plurality of independent micro communication devices, each of the plurality of independent micro communication devices configured to communicate and connect with each other and display a nature of their connectivity, wherein the plurality of independent micro communication devices are programmed for use within an entertainment environment, wherein the entertainment environment is one of a real world and a virtual world, and wherein the plurality of independent micro communication devices are configured to exchange information and media amongst one or more of the plurality of independent micro communication devices.

In an embodiment, the entertainment environment is a gaming environment, wherein the gaming environment comprises digital projections within a client device, wherein the digital projections and the gaming environment are based on the location of the client device within the gaming environment, wherein the location of the gaming environment is based on an overlay of a virtual map over a real map.

In an embodiment, each of the plurality of independent micro communication devices is configured to augment displays of one or more of the plurality of independent micro communication devices, induce sounds in one or more of the plurality of independent micro communication devices, determine position of one or more of the plurality of independent micro communication devices, and derive information via one or more sensors, wherein the one or more sensors are disposed within at least one of the plurality of independent micro communication devices.

Provided may be a system comprising a memory storing user information associated with each of a plurality of clients; a processor configured to evaluate, via a commonality evaluator, whether two or more of the plurality of clients surpass a commonality threshold, the two or more of the plurality of clients comprising at least a first client and a second client, wherein the commonality threshold is a summation of any one of a physical commonality threshold, a virtual commonality threshold, and a social systematic commonality threshold, wherein the physical commonality threshold is defined by reception of a signal, wherein the virtual commonality threshold is defined by reception of an electronic correspondence in a computing environment, and wherein the social systematic commonality threshold is defined by one or more connections between the plurality of clients; determine, via a likeness evaluator, whether the two or more of the plurality of clients share one or more common interests; determine whether at least one of the two or more of the plurality of clients surpasses an information sharing inclination metric; determine whether the two or more of the plurality of clients surpass an likeness threshold, the likeness threshold based on at least the one or more common interests and the information sharing inclination metric; record, if the two or more of the plurality of clients surpass the commonality threshold and the likeness threshold, an associated information exchange between the two or more of the plurality of clients; a plurality of client devices comprising at least a first client device and a second client device, the first client device associated with the first client, the first client device configured to receive at least the associated information exchange from a processor, the first client device configured to transmit the associated information exchange to at least the second client device associated with the second client; an indicator device in informatic communication with at least one of the plurality of client devices, the indicator device configured to output an indication upon reception of the associated information exchange from a transmitting client device, the indicator device comprising at least one of a vibrational motor, a speaker, and a light indicator, wherein the output of the indication comprises actuation of one of the vibrational motor, the speaker, and the light indicator, and wherein the indicator device is a wearable component adapted to reversibly affix to at least one of the two or more of the plurality of clients.

In an aspect, the one or more common interests are discernable from client-specific data collected from the plurality of clients, wherein the client-specific data was derived from one of: a questionnaire, an external information source, or an artificial intelligence model output, wherein the artificial intelligence model output is output from an artificial intelligence model configured to generate generative client-specific data for one or more of the plurality of clients.

In an embodiment, the system further comprises a mesh communication system comprising a plurality of nodes, the plurality of nodes comprising one or more of the plurality of client devices and/or one or more of the indicator devices in informatic communication with at least one of the plurality of client devices, wherein a relativistic commonality of each of the plurality of nodes is based on Global Positioning System (GPS) information, a network of positioning sensors, a signal strength of transmission or reception of one or more of the plurality of nodes, and/or a capacitance power metric between two or more of the plurality of nodes.

In an aspect, the computing environment comprises a virtual convention, and/or a machine convention.

In an aspect, the one or more connections between the plurality of clients is further defined by commonality of intellectual or common characters in organizations.

In an aspect, the first client device configured to transmit a notification to one or more of the plurality of clients, wherein the notification actuates the indicator device, wherein the notification comprises an opt-in option and an opt-out option, wherein the opt-in option is configured to connect the first client device to the one or more of the plurality of clients, and wherein the opt-out option ceases the notification.

In an aspect, the indicator device of the first client is configured to transmit an introduction request from the first client to the second client, wherein, upon transmission of the introduction request, a mirror of the introduction request generates on the display indicator of the second client and the introduction request generates on the display indicator of the first client, wherein the introduction request comprises an identifying characteristic of the second client and the mirror of the introduction request comprises an identifying characteristic of the first client.

In an aspect, acceptance of the introduction request transmits a “wink” to the first client and denial of the introduction request transmits a “frown” to the first client.

In an aspect, the processor may be configured to facilitate transfer of information between the first client and the second client upon the associated information exchange, wherein the memory is configured to maintain a history of said information, wherein the associated information exchange and transferred information is stored locally on the first client device and the second client device, and wherein the associated information exchange may be accessible via an authentication credential.

In an aspect, the processor may be configured to transmit an event request to the first client and the second client based on the associated information exchange.

These and other aspects, features, and advantages of the present invention will become more readily apparent from the following drawings and the detailed description of the preferred embodiments.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 is an illustrative block diagram of a system based on a computer configured to execute one or more aspects of the functionality described herein.

FIG. 2 is an illustration of a computing machine configured to execute one or more aspects of the functionality described herein.

FIG. 3 is an illustration of an embodiment of a client suite.

FIG. 4 is an illustration of communication between a plurality of client suites.

FIG. 5 is a workflow depicting a method of connecting two or more client devices.

FIG. 6 is an illustration of communication between a plurality of client suites based, in part, on commonality assessment.

FIG. 7 is an illustration of an indicator device for use with the commonality assessment described herein.

FIG. 8 is an illustration of communication between a plurality of client suites based, in part, on commonality assessment.

FIG. 9 is an example embodiment, utilizing the client suite for aquatic navigation and information retrieval.

FIG. 10 is an example embodiment, utilizing the client suite for air navigation and aviation drone communication.

FIG. 11 is an example embodiment, utilizing the client suite for group interaction and subgroup communication.

FIG. 12 is an example embodiment, utilizing the client suite for a hospital network communication system.

FIG. 13 is an example embodiment, utilizing the client suite for military operations and communication.

FIG. 14 is an example embodiment, utilizing the client suite for robotic hand manipulation and imaging.

FIG. 15 is an example embodiment, utilizing the client suite for security access.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

The present disclosure contemplates a methods, systems, apparatuses, and software applications designed to identify users, including human entities and/or devices, that exhibit a shared likeness for one or more subjects and/or other users or devices. The embodiments disclosed herein offer a means for a searching user/device to discover and establish connections with one or more matching users/devices, fostering the exchange of ideas, information, procedures, and activities among them.

Moreover, the disclosed embodiments provide functionality to determine and/or enable users to define various preferences, encompassing but not limited to commonality preferences, likeness preferences, and privacy preferences. The comprehensive suite of methods, systems, apparatuses, and software applications described herein serves the purpose of identifying matching users/devices who share a likeness for specific subject(s) with a searching user.

The disclosed embodiments may empower searching users/devices to locate and connect with matching users/devices based on defined parameters. These parameters include the physical and/or virtual commonality of the users/devices, shared likeness subjects, and privacy preferences linked to the users/devices. Throughout the matching and connecting process, the embodiments incorporate a notification mechanism to keep users/devices informed, while also providing a framework for connected users/devices to share information with each other, whether through manual or automatic means. This innovative approach enhances the efficiency and precision of connecting users/devices based on shared likenesses and commonality.

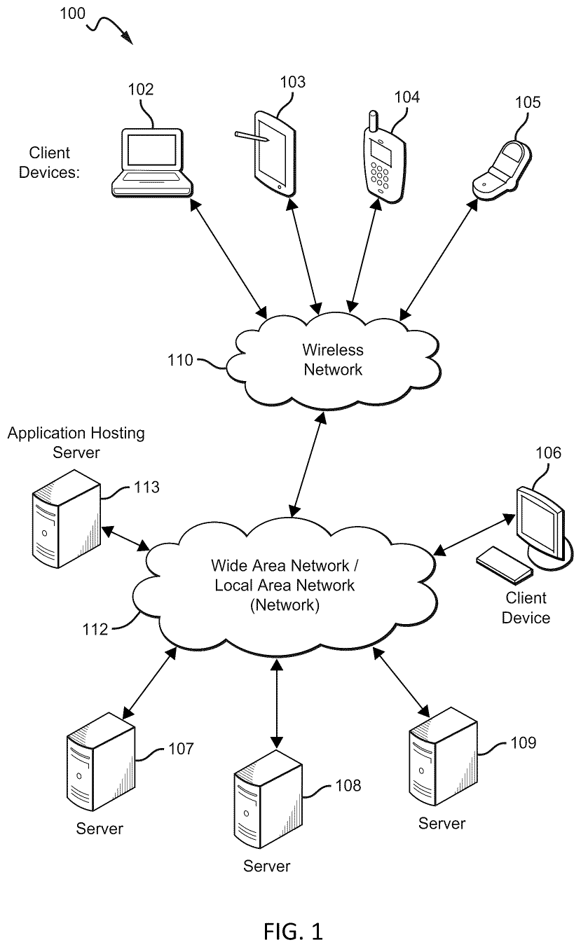

FIG. 1 illustrates components of one embodiment of an environment in which the invention may be practiced. Not all of the components may be required to practice the invention, and variations in the arrangement and type of the components may be made without departing from the spirit or scope of the invention. As shown, the system 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. Various of the client devices 102-106 may include, for example, desktop computers, laptop computers, set top boxes, tablets, cell phones, smart phones, smart speakers, wearable devices (such as the Apple Watch) and the like. Servers 107-109 can include, for example, one or more application servers, content servers, search servers, and the like. FIG. 1 also illustrates application hosting server 113.

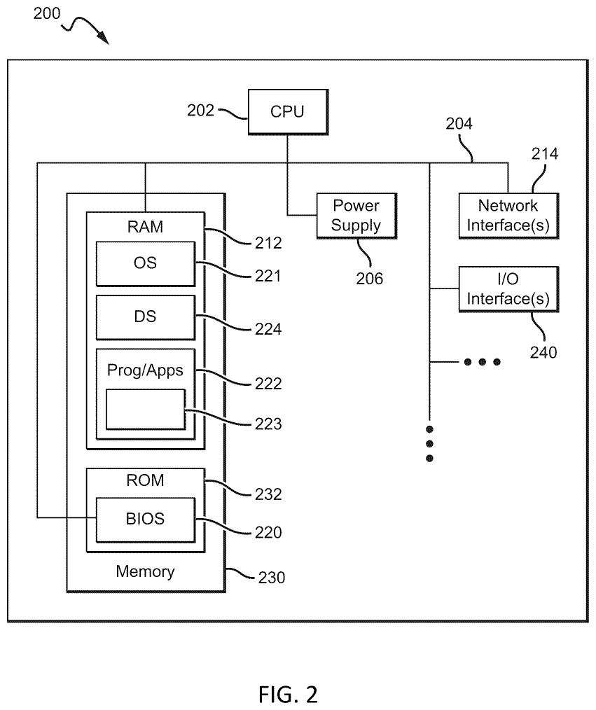

FIG. 2 illustrates a block diagram of an electronic device 200 that can implement one or more aspects of an apparatus, system and method for increasing mobile application user engagement (the “Engine”) according to one embodiment of the invention. Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software and other tools necessary to implement or facilitate methods and systems according to embodiments of the invention. The elements may exist on a single computer or be distributed among multiple computers, servers, devices or entities.

The power supply 206 contains one or more power components and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server may, for example, host a web site that can provide a user interface for administration of example aspects of the Engine.

Any computing device capable of sending, receiving, and processing data over a wired and/or a wireless network may act as a server, such as in facilitating aspects of implementations of the Engine. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system and method of the Engine. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the Engine. Content may include, for example, text, images, audio, video, and the like.

In example aspects of the apparatus, system and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system and method embodying the Engine, may range widely in terms of capabilities and features. For example, a cell phone, smart phone or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, commonality sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices 102-106, for example, as may be used in an example apparatus, system and method implementing the Engine, may run a variety of operating systems, including personal computer operating systems such as Windows, iOS or Linux, and mobile operating systems such as iOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, system and method implementing the Engine, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. Thus, in various embodiments, a non-transitory computer readable medium may comprise instructions stored thereon that, when executed by a processing device, cause the processing device to carry out an operation. In such an embodiment, the operation may be carried out on a singular device or between multiple devices (e.g., a server and a client device). A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system and method implementing the Engine, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2 G), 3rd (3 G), 4th (4 G), 5^{th} (5G) generation, Long Term Evolution (LTE) radio access for cellular systems, WLAN, Wireless Router (WR) mesh, and the like. Access technologies such as 2G, 2.5G, 3G, 4G, 5G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the Engine, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present invention include apparatuses, systems, and methods implementing the Engine. Embodiments of the present invention may be implemented on one or more of client devices 102-106, which are communicatively coupled to servers including servers 107-109. Moreover, client devices 102-106 may be communicatively (wirelessly or wired) coupled to one another. In particular, software aspects of the Engine may be implemented in the program 223. The program 223 may be implemented on one or more client devices 102-106, one or more servers 107-109, and 113, or a combination of one or more client devices 102-106, and one or more servers 107-109 and 113.

As noted above, embodiments of the present disclosure may relate to apparatuses, methods, and systems for client device communication and connectivity and commonality assessment thereof. The embodiments may be referred to simply as the system.

The system may utilize the computerized and network elements as described above and as illustrated in FIGS. 1-2. Accordingly, the system may include hardware and software elements (as embodied in system 100 and electronic device 200) configured to execute the features of the algorithms and workflows described herein. For the purposes of this disclosure, it is understood that actions, functionalities, and characteristics of the “client suite” may be shared across all or any one of “client,” “client device,” “user,” or the like. Thus, the actions, functionalities, and characteristics described herein should not be read as limited to any one of the devices or components described herein, unless expressly recited otherwise.

The system described herein may address a common challenge encountered in group settings such as meetings or conferences, where individuals wish to connect with others but lack awareness of their respective characteristics. In such scenarios, participants aim to establish new contacts but may inadvertently overlook someone who could be interesting or precisely the person they are looking to meet. Identifying individuals with shared interests becomes challenging. The proposed system overcomes this issue by introducing a matching algorithm, an indicator device, and communication system thereof that not only allows instant and local information exchange but also indicates shared characteristics. As a nonlimiting example, the system described herein may be utilized in a scenario where a seller of a particular category of widgets seeks to connect with a buyer of the same category of product. The system may identify the associated information exchange, facilitating introduction and information exchange.

While traditional events may use conventional adhesive name tags, this disclosure provides a more dynamic alternative to enhance networking opportunities. The system extends its applicability beyond simple networking, finding utility in diverse settings such as medical facilities, universities, research institutes, corporate environments, factory floors, and even gaming applications.

In a research institute or medical facility, where information exchange is crucial, the instant disclosure offers a solution. On a factory floor, the system may optimize the flow of information and instructions among robotic devices or machinery. Additionally, the instant disclosure may address the challenge of connecting users with similar interests and needs within associated organizations or common interest areas.

Moreover, the system of the present disclosure tackles the issue of facilitating the exchange of ideas and information in virtual environments beyond simplistic distance measurement models. The system of the present disclosure goes beyond a simple approach or basic trend analysis, aiming to foster connections among users and promote collective understanding and learning from shared experiences.

Therefore, the system described herein may be arranged in a number of configurations, including, but not limited to, a personal physical local usage configuration (i.e., an individual at a trade show, medical facility, or other similar physical setting); a robotic physical local usage configuration (i.e., a system of automated components or robotic entities adapted to interact with each other or interface with people; such settings may include a factory floor, a smaller “makers shop,” or a home computerized system); a virtual reality application configuration (i.e., a setting enabling users to interact in a virtual reality world, where exchange of information between users is permitted); and/or a social group configuration (i.e., an institution, club, organization, or other group allowing users to converge to exchange information and ideas).

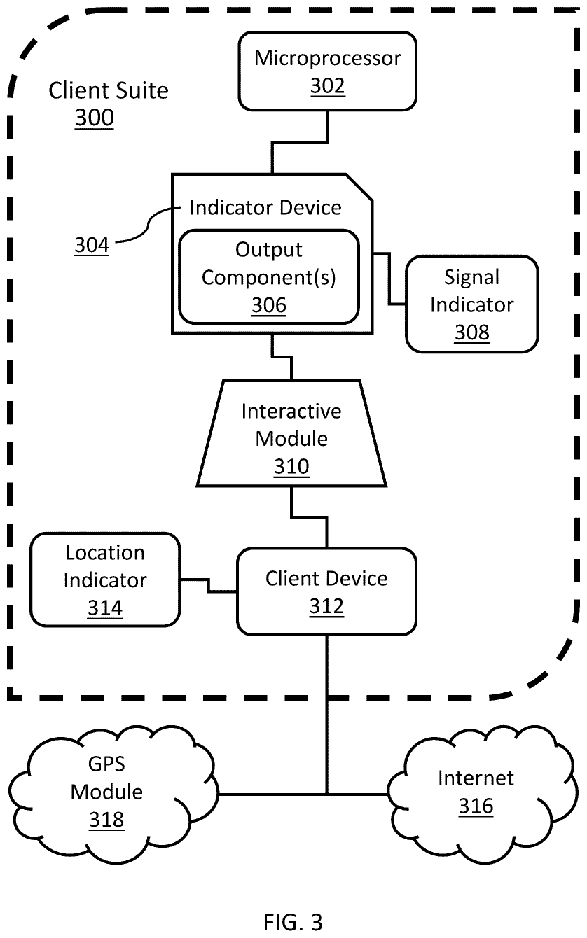

For the purposes of this disclosure, the device(s) associated with a user may be referred to as the “client suite.” Thus, any of the steps described herein may be executed by any of the devices or components within a client suite or tangential to a client suite. Referring to FIG. 3, a client suite may comprise a microprocessor. In such a setting, a microprocessor may serve as the brain of the connected devices and components within the client suite, enabling such devices and components to process, receive, transmit, and interpret data from various inputs and outputs. The microprocessor's function may involve executing computer-readable instructions, managing data, and facilitating communication between interconnected devices or other client suites (and components thereof). The microprocessor (also referred to as a logic chip or “mini computer”) may be capable of storing data and communicating wirelessly along a WIFI or Bluetooth signal. For the purposes of this disclosure, the microprocessor of FIG. 3 may embody any of the processor functionality described above regarding FIG. 2. Further, for the purposes of this disclosure, “client suite,” “client device,” and “chip” may refer to the same device. Accordingly, functionality or an application directed to a “client device” may equally be carried out by a “chip” or “client suite.”

FIG. 3 illustrates an embodiment of a client suite 300, the client suite 300 may comprise a microprocessor 302, an indicator device 304 comprising an output component 306, a signal indicator 308, an interactive module 310, a client device 312, and a location indicator 314. The client suite 300 may be communication with an internet 316 and GPS module 318.

The client suite may include an indicator device. The indicator device may be an internal or external component configured to emit one or more outputs, for example, via the one or more output components. The indicator device may be in informatic communication with at least the microprocessor, the interactive module, and/or the client device. Further, the indicator device may be in direct network communication with the internet or any suitable communication network. The output components may include a display screen, LED indicators, vibrational motor, speaker, and/or other output components configured to make an indication apparent via any of the senses. In further embodiments, the indicator device is capable of receiving and transmitting signals with other components external to the host client suite. For example, the indicator device may be configured to send and receive signals with other indicator devices in other client suites. The indicator device, in addition to providing a perceivable output (e.g., audio, visual, etc.), may be configured for the reception and/or transmission of instructions or other data. As a nonlimiting example, the indicator device may be adapted to receive data from another indicator device or any suitable third-party device. Further, the indicator device may be adapted to transmit data to any other indicator device or suitable third-party device. In either or both instances, the indicator device may further transmit to the client device (or other client suite component) after reception/transmission from/to another indicator device.

In an embodiment, the indicator device is in informatic communication with a signal indicator. The signal indicator may be adapted to utilize commonality-based technology to provide real-time assessments of signal strength, offering accuracy and efficiency in optimizing communication between devices and/or facilitating matches between devices. The signal indicator may include one or more sensor components adapted to detect and analyze signals emitted by neighboring client suites or other signal-emitting devices. By gauging the strength of the signal, the commonality of these signal sources may be determined. The signal indicator may be configured to equate the strength of a signal to measure the distance between neighboring client suites. This commonality data may then be utilized to display a commonality indicator and/or inform the workflows described herein. Further, the signal indicator is adapted to function in real-time, allowing the client suite to monitor changes in signal strength, and thus commonality, as two client devices move relative to one another. This dynamic responsiveness ensures that the commonality determination is based on the latest available information.

In an embodiment, the client suite comprises an interactive module. The interactive module may be in communication with at least the client device and/or the indicator device. The interactive module may be a portable and/or an external device equipped with one or more input sensors (e.g., tactile sensor) and/or communication interfaces (e.g., for receiving and transmitting signals between the interactive module, client device, microprocessor, and/or indicator device). The interactive module may be configured to detect and interpret inputs (e.g., tactile input) provided by a user, translating such inputs into actionable commands for the associated components (e.g., the indicator device, the microprocessor, and/or the client device). The interactive module may be equipped with communication interfaces to establish a seamless (wireless and/or wired) connection with the indicator device and/or the client device. The interactive module may comprise an independent microcontroller for input interpretation. However, the interactive module may also be configured to utilize the microprocessor (or other suitable component) of the client suite to interpret the interactive module received input. In an embodiment, the interactive module may be configured to accept or reject a pending associated information exchange, wherein a user may provide tactile input (or another input type) into the interactive module to communicate whether the user seeks to connect with the pending associated information exchange or not.

The client suite may be in communication with a client device. The client device may be a smartphone or other personal computing device, with a means for internet connectivity and integration with the client suite. The client device may embody the components and/or functionality of the electronic device 200.

The client suite may be in communication with a Global Positioning System (GPS) module. The client device may be in communication with a location indicator, wherein the location indicator is configured to identify and locate other client suites within a predetermined area. The location indicator may employ any suitable approaches, for example, utilizing the GPS module and/or a relativistic assessment of signal strength of neighboring client suites. In the GPS embodiment, the location indicator may leverage the GPS module to find the position of the client suite, providing absolute coordinates. Simultaneously, in the GPS embodiment, the location indicator may receive information from the GPS module comprising the absolute coordinates of other client suites. The client device, microprocessor, or other component of the client suite may be configured to leverage the absolute coordinates of the instant client suite and the absolute coordinates of the surrounding client suite(s) to determine which client suites are within the predetermined commonality threshold of the instant client suite. In a relativistic approach, signal strength may be analyzed from nearby client suites (e.g., via the signal indicator and processes thereof). In further embodiments, the relativistic approach and the GPS approach may supplement one another and/or may be used in conjunction. For example, the location indicator may utilize algorithms to combine data from both GPS and relativistic approaches, optimizing accuracy and minimizing errors.

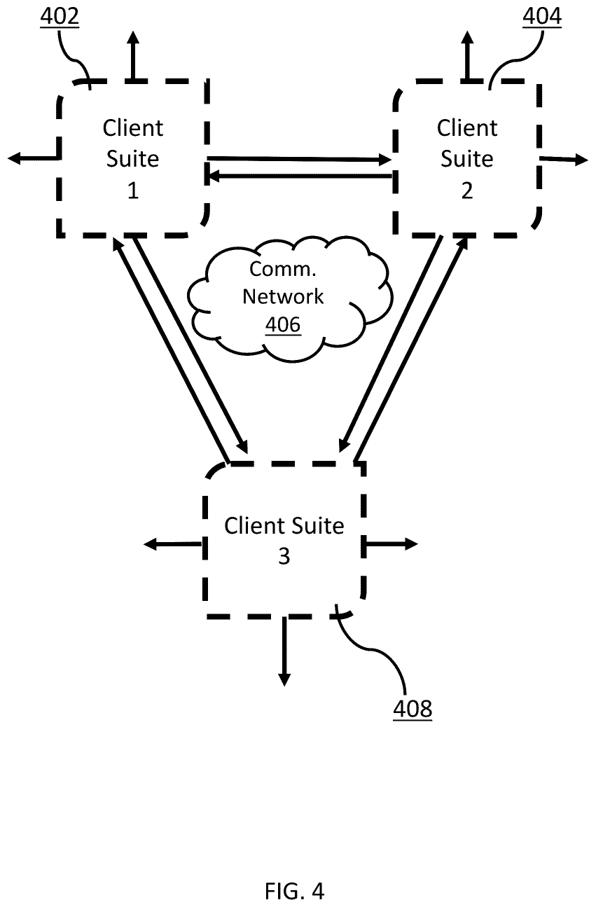

Referring to FIG. 4, each of a plurality of client suites may transmit an outgoing signal. For the purposes of this disclosure, the client suite should be understood to embody any one or more of the client devices, the indicator device, the microprocessor (or “chip”), the interactive module, the signal indicator, and/or the location indicator. The outgoing signal may be continuously output from each of the plurality of client suites. Similarly, each of the plurality of client suites may be configured to receive the outgoing signal from any of the other client suites. Each of the outgoing signals may include one or more characteristics that link the outgoing signal to an identity of a particular client suite. For example, each outgoing signal may comprise a unique JSON string. As outgoing signals are received, each of the received outgoing signals are appended in a list. The list may be stored locally in the receiving client suite and/or may be stored in a cloud or database accessible by any number of the client suites.

FIG. 4 illustrates an embodiment of a first client suite 402 in communication with a second client suite 404 and a third client suite 408. The communication between the first client suite 402, the second client suite 404, and the third client suite 408 may occur via a communication network 406. For the purposes of FIG. 4, each of the client suits 402/404/408 may embody the characteristics and/or components of the client suite 300 depicted in FIG. 3 and described above.

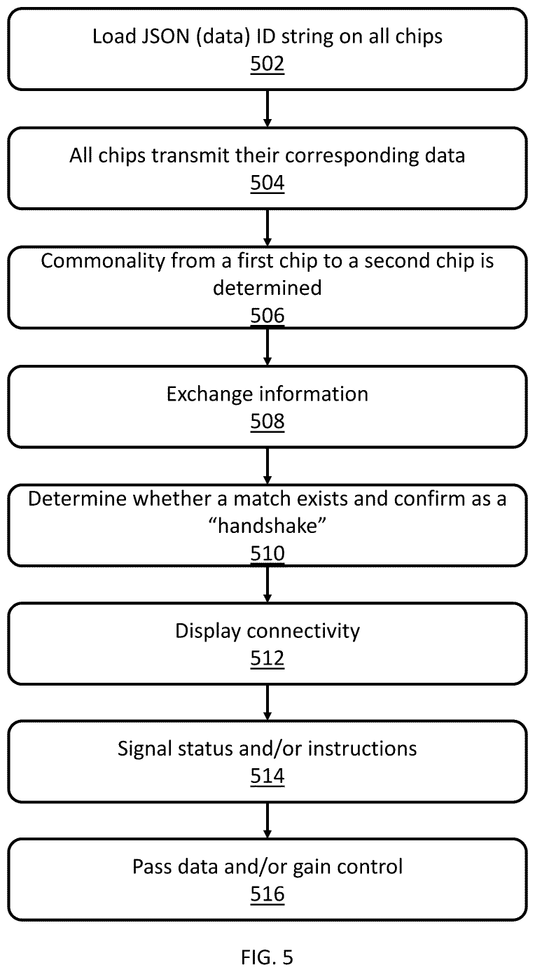

FIG. 5 illustrates an embodiment of a method for connecting two or more client suites. At step 502, a JSON ID string or other similar data element may be loaded into each of the chips. For the purposes of this disclosure, “chips” may refer to the microprocessors within each of the client suites, stand-alone computer units, the entire client suite, and/or any suitable component of the client suite.

In order to build the JSON ID string, information may be collected directly from each of the client suites and/or indirectly from the underlying user. In one embodiment, a central database may be maintained of all users or client suites and characteristics associated with each of the users or client suites. As a nonlimiting example, the fields of the database may include, but are not limited to, identifying data of the user, identifying data of the client suite or components thereof, institutional data related to the user's groups or clubs, data extracted from social media or a third-party system, or any other suitable characteristic data. In various embodiments, the fields may be modified and adapted to specific purposes and concerns. As described above, the client device ID may also be inputted to the central database and/or assigned to the user, to associate the user ID info with the hardware device(s) being used.

In various embodiments, such data may be collected via one or more collection procedures. In one aspect, a user may fill out a form, for example, presented on the client device. In such an embodiment, upon the initiation of the process the user may be presented with a computer-fillable form or questionnaire. In another aspect, a central administrator may provide such information based upon an existing database. For instance, if the use of the system herein is in regard to a school, corporation, public initiation, or other suitable group, the administrator may interface the existing database with the central database. The central database and overall system may provide a template for such an interface and may be configured to assign appropriate hardware identification. In another aspect, a proprietary search program may be utilized to research the users on the Internet, social media, and the like as to ascertain the user's information. In such an embodiment, web crawlers or other scraping techniques may be employed. In yet another aspect, the system may leverage prior usage data to upgrade and learn the nature of the user and modify the user ID profile. In such an example, artificial intelligence models may be employed to discern likely characteristics of the user based on the prior usage data or data of other users.

Thus, for the purposes of this disclosure, the system may contemplate both user ID information (e.g., information related to the user of the system) and device ID information (e.g., information related to the underlying devices and/or components of the system).

In an embodiment, the system employs a JSON object string defining the characteristics of the user (e.g., the user ID information and/or the device ID information). As a non-limiting example, this data object may be named “myJSON_id #”. However, the data may be stored in any format that is readable and transferable. As contemplated above, each user may have a unique “myJSON_id #”. Although this data may be stored in the central database, in a smaller or private system, this information may be stored privately or locally.

Once the data is collected and formatted it may then be transferred to the client device and/or the client suite. This may be achieved by downloading the data or “myJSON_id #” to the client suite and/or the “chip” (microprocessor). As a non-limiting example, this process may occur via an internet API or via the download capability from the client device.

At step 504, all chips transmit their corresponding data, for example, as beacons. Interaction among the chips within an environment may occur in various settings, ranging from a confined physical space, like a room, to larger physical and/or intangible spaces, such as institutions or social media communities. In the context of “personal physical local usage,” the environment surrounding said personal physical local usage typically constitutes a communal space. Within this shared area, individual client suites or chips may engage in data transmission.

In an embodiment, a “beacon signal” carrying the user's data object, identified, for example, as “myJSON_id #,” is broadcasted to all other client suites or chips present in the environment. As contemplated above, each “chip” or client suite consistently emits an outgoing signal containing the chip or client suite's corresponding information, which is received by all other chips or client suites within the same environment. In such a scenario, the transmitting chip or client suite may also function as a receiver, establishing a reciprocal reception of one or more outgoing signals. Such an interaction may be implemented through various protocols (e.g., Wi-Fi, a Bluetooth, or any suitable electronic data transmission protocol).

At step 506, commonality from a first chip to a second chip is determined. As described above, the “beacon” nature of this configuration enables the system to identify the location and/or commonality of neighboring client suites. Several methods can be employed for this purpose, including relativistic signal strength assessment, GPS assessment, RF signaling, pier locating assessment, and capacitance sensing (described below). In an embodiment, the identification of location is then integrated into the transmitted data from the beacon.

The beacon ID transmission protocol may comprise the following steps. For a set period of time, all client suites individually receive the “myJSON_id #” packets from each of the plurality of client suites. In each of the receiving client suites, the received data may be renamed “yourJSON_id #” and may include amended data containing suitable location information. All such transmission and reception of data may be collectively complied to create a “yourJSONDataObject,” which may include all outgoing data from all client suites.

At step 508, information is exchanged between chips. At this step or any other suitable step, an opt-in or opt-out option may be provided to the user's associated with either of the chips. Accordingly, via interaction with the client device or other component within the client suite, the first or second user may determine whether to proceed with matching with the other user. In another embodiment, additional information may be transferred between client devices based upon a system of approvals. This system of approvals may be referred to herein as “winks” (wherein denials are referred to as “frowns”). As a nonlimiting example, after the system determines an associated information exchange, a client may be enabled to “wink” at the other matching client, and the other matching client may be enabled to “wink” back at the client that initially “winked.” After the final “wink,” transmission of data, documents, etc. may be permitted between the two clients. The “wink” may utilize any of the signal or packet transmission protocols recited in the instant disclosure.

At step 510, the system may determine whether an associated information exchange exists between two or more client suites, for example, based on the user ID information and/or the device ID information, and confirm as a “handshake.” After confirmation of information exchange between a transmitting chip and receiving chip, a comparison is made between the members of the data object and the user's own identification information. As a non-limiting example, the user's “myJSON_id #” is compared with all the received “yourJSON_id #” data to search for commonality and matching. Such a search for commonality and matching is subject to the applied algorithms defined and described in this disclosure. In a further embodiment, a “filter” may be applied to the incoming data to limit the selection of the “matched” device. In such a nonlimiting example, the filter may be based upon “commonality” (e.g., based on the signal strength assessment described above). Accordingly, commonality as determined by signal strength may be utilized to list each of the pending matches in order of distance, allowing the most proximal matches to manifest first. At the filter step, other considerations may be applied, as well (e.g., matching may be limited to those client devices associated within a particular group).

At step 512, the connectivity between the first and the second chip is displayed. At such a step, information corresponding to the first chip may be relayed to the second chip and information corresponding to the second chip may be relayed to the first chip, such that the user's associated with each chip may view the connection.

At step 514, the first chip and/or the second chip may signal the status of the connection. For example, the first chip and/or the second chip may transmit a signal to the other chip indicating the status of the connection. In an embodiment, at step 514, for example including one or more robots or computerized actors, computer-executable instructions may be provided to the receiving chip. In such an embodiment, the connection may facilitate an action in the receiving chip.

At step 516, the first chip and/or the second chip may transmit data to the receiving chip. In such an embodiment, the sending chip may gain control of the receiving chip, for example, allowing the sending trip to induce action in the receiving chip remotely.

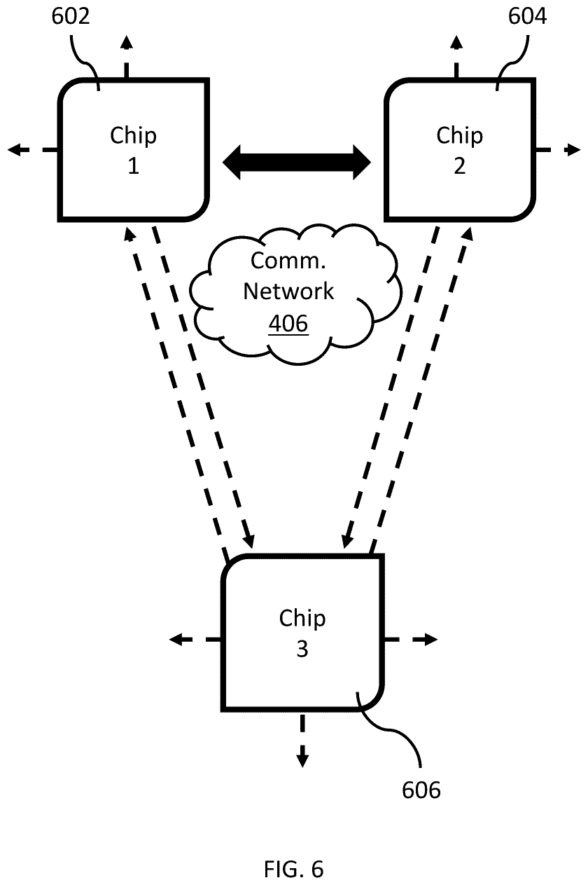

FIG. 6 illustrates an embodiment of the commonality threshold determination between three chips. As shown in FIG. 6, each chip may transmit packets as beacons, for example, represented as the dashed lines between chips. The system, as described above, may determine to match two or more chips based on commonality (e.g., physical commonality, institutional commonality, etc.). Thus, in FIG. 6, Chip 1 and Chip 2 have matched (demonstrated by the solid arrow between Chip 1 and Chip 2) based, in part, on the commonality of Chip 1 to Chip 2. Conversely, Chip 3 may not match with Chip 1 or Chip 2 due to the lesser commonality, even if, for example, Chip 1 and Chip 3 share user characteristics that would facilitate a likeness match otherwise.

FIG. 6 illustrates an embodiment of a first chip 602 in communication with a second chip 604 and a third chip 606. The communication between the first chip 602, the second chip 604, and the third chip 606 may occur via a communication network 406. For the purposes of this disclosure, the first chip 602, the second chip 604, and/or the third chip 606 may embody any of the “client suites” described above and/or any components thereof.

In various embodiments, the chips (or client suites or components thereof) may be configured to maintain information and the connection itself within a private network (e.g., stored locally within each chip (or client suite or component thereof). As a nonlimiting example, the system may be configured to juxtapose “private devices” and “public devices.” In such a nonlimiting example, a “private device” may refer to devices and components within a local network, within a particular connection (e.g., the two devices in communication), or within any predetermined metric (e.g., a particular geographical area, a certain number of devices, certain types of devices, etc.). A “public device” may refer to devices and components outside of the local network (describe above). Thus, different actions may be enabled to be carried out with private devices and/or public devices. Accordingly, the system may be configured such that transmission of the initial signal (e.g., the signal attempting to form a connection) is transmitted via the “public” infrastructure, while data transfer after said connection (e.g., transmission of instructions between two connected devices) is transmitted via the “private” infrastructure.

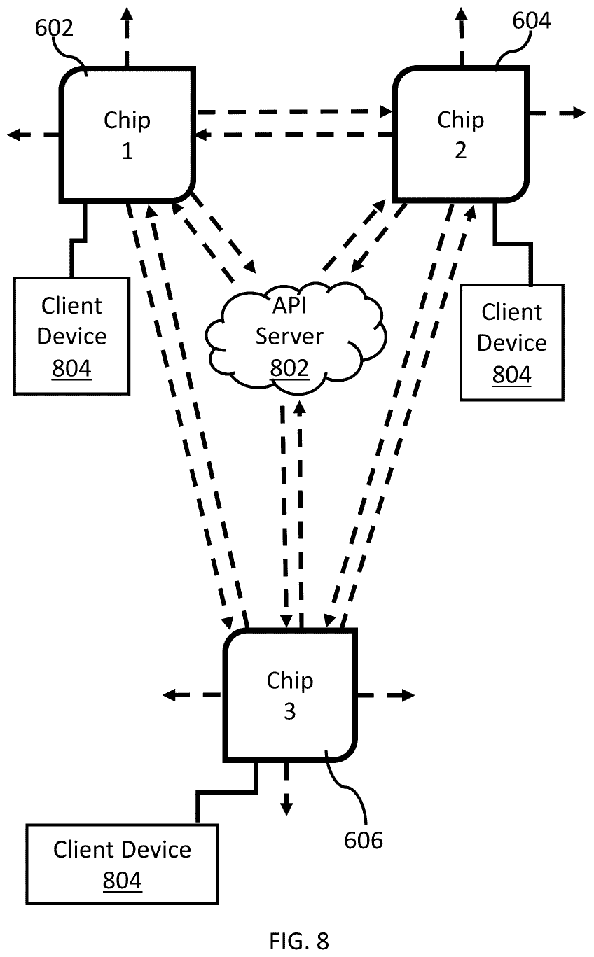

FIG. 8 is an illustration of communication between a plurality of client suites based, in part, on commonality assessment. FIG. 8 illustrates an embodiment of a first chip 602, a second chip 604, and a third chip 606 all in communication with one another. The first chip 602 may be connected to a client device 804 and may be in communication with an API server 802. The second chip 604 may be connected to the client device 804 and may be in communication with the API server 804. The third chip 604 may be connected to the client device 804 and may be in communication with the API server.

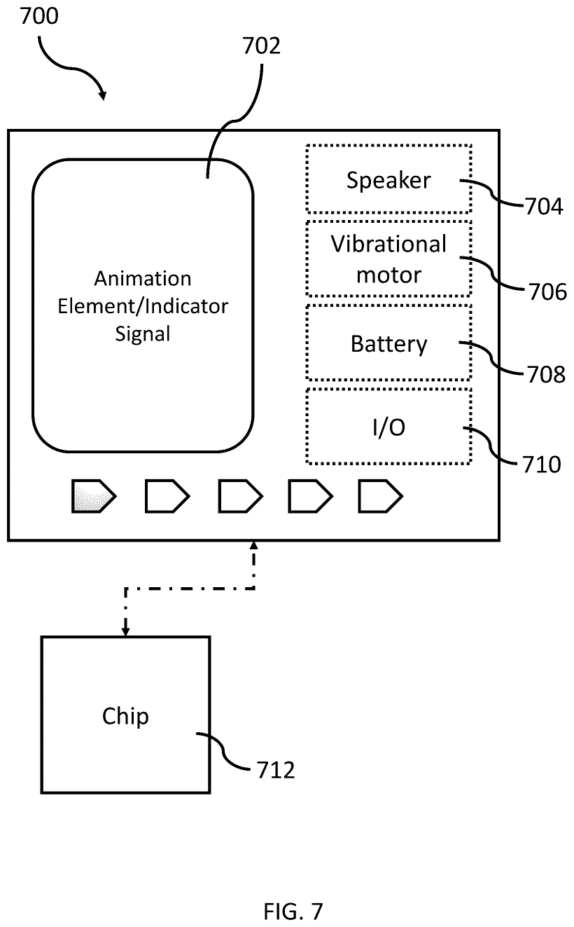

FIG. 7 illustrates an embodiment of an indicator device. The indicator device may include an animation element, one or more indicator lights, a speaker, a vibrational motor, a battery, and/or input/output interfaces. The animation element may be an audiovisual aspect displayed via a display screen and/or speaker. For example, in some embodiments, if a first user and a second user match, an animated aspect correlated to the first user may display on the second user, such that the first user may be able to discern which user they have matched with, based on knowledge of their own animated aspect. In further embodiments, in addition or in replacement of the animation element, the device may be configured with an indicator signal wherein the indicator signal includes the identity of one or more of the connecting parties. Thus, in an example where Device A has connected with Device B, Device A may transmit an indicator signal including identification information for Device B, such that Device B may identify Device A as a matched device. In such embodiments, indicator devices may enable one party to find another party based on identifying data in a generated ID icon, animation, signal, or tune. Thus, such a protocol may enable visualizing of identifying data of a first party in the transmissions of a second party for use with human interactions (e.g., to see/discover the other) and/or robotic interactions (e.g., robots drawn to signals contain identifying data).

FIG. 7 illustrates an embodiment of an electronic device 700 which may comprise an animation element or indicator signal 702, a speaker 704, a vibrational motor 706, a battery 708, and an input/output device 710. A chip 712 may be connected to, and in communication with, the electronic device 700.

In an embodiment, the system may comprise a plurality of client devices or client suites comprising, for example, at least a first client suite and a second client suite. In an embodiment, the first client suite may be configured to transmit, if one or more conditions are in commonality across the first client suite and the second client suite, a request to the second client device; and the second client suite may be configured to receive, from the first client device, the request. Further, in such an embodiment, the second client suite may be configured to extract, from the request, a first client device identifier; and displaying, via the second client suite, the first client device identifier.

In another embodiment, the system may comprise a plurality of client devices or client suites comprising, for example, at least a first client suite and a second client suite. In an embodiment, the first client suite may be configured to transmit a request to the second client device; and the second client suite may be configured to receive, from the first client device, the request; extract, from the request, if one or more conditions are in commonality across the first client device and the second client device, a first client device identifier; and display, via the second client device suite, the first client suite identifier.

In effect, if commonality is determined between two devices, a first party's likeness or identifier may be displayed in a device associated with the second party, such that the first party may see themselves in the second party device. Accordingly, in a further embodiment, the second party's likeness may be displayed in the first party device. As a nonlimiting example, if the system is utilized in a conference hall, guests walking the hall may “see themselves” in another guest's indicator device.

In further embodiments, for example those comprising robots or other devices, the likeness of one party being visible in the other party's device may manifest as an emanating signal, wherein said emanating signal include the identity of the matched robot or device. As a nonlimiting example, a first robot may be determined to share commonality with a second robot, wherein the first robot may transmit a signal comprising the identity of the second robot, such that, when the signal is interpreted by the second robot, it is clear to the second robot that the signal is correlated to itself.

The matching elements of the workflows described above may utilize a commonality matching method and a likeness matching method. Each of these methods may be utilized in a combined matching algorithm.

The commonality matching method, as illustrated in the described embodiment, is a process designed to connect users based on their “closeness” at a given time. It initiates with the system receiving identification and location information from a first client device. By determining the corresponding user account associated with this client device or client suite, the system updates the user's location information and repeats the process for a second user device. Commonality may be evaluated by comparing the location information of the two users and checking if it satisfies a commonality threshold, which may be system-defined or user-defined. In various embodiments, as described above, the commonality matching method may utilize various location-tracking technologies, including GPS, relativistic location assessment via signal strength determinations, and more. The resulting commonality associated information exchange may trigger a notification or indication to the user(s), indicating the commonality associated information exchange and potentially sharing user information. In some embodiments, one or more of the two users may opt to continue with the associated information exchange or decline the associated information exchange.

The likeness matching method, in contrast, may focus on connecting users/devices based on shared interests, preferences, and other relevant criteria. The system may receive identification information from user devices and associated user accounts. Such identification information may include contact details, interest, organization affiliation, and more. Likeness matching may involves analyzing the users' likeness information, which may include shared interests or demographic characteristics. Likeness scores are calculated, considering weights and thresholds, to determine the level of commonality between users/devices. The resulting commonality associated information exchange may trigger a notification or indication to the user(s), indicating the commonality associated information exchange and potentially sharing user information. In some embodiments, one or more of the two users may opt to continue with the connection or decline the connection at any time.

These two methods can be combined into an integrated algorithm for a comprehensive user/device matching approach. The algorithm starts with commonality matching to identify users in close physical commonality. Once potential matches are found, the system further refines the connections through likeness matching, considering shared interests. This dual-stage process ensures that users/devices not only share a proximal space but also have common interests, increasing the likelihood of meaningful connections. The algorithm leverages location-tracking technologies and considers both physical and virtual commonality. Notifications are sent to users upon determining a commonality and/or likeness associated information exchange, fostering user connections based on both geographical closeness and commonality.

The system described herein may include a capacitance embodiment. The capacitance embodiment relates to a commonality detection system that utilizes capacitance elements embedded within client devices or suites to establish and quantify the spatial commonality between two or more client devices or suites. Accordingly, each client device and/or client suite may be equipped with a capacitance element, which may be integrated into the component's housing or positioned strategically on the component's surface. The capacitance element may be adapted to sense and measure changes in capacitance induced by the presence of nearby objects, specifically other client devices and/or client suites equipped with similar capacitance elements. By leveraging the inherent electrical properties of capacitance, the system establishes a dynamic and responsive means of determining the commonality of two client devices and/or client suites. The capacitance-based commonality detection may enable the implementation of intuitive and seamless interactions between users.

As a nonlimiting example, the capacitance embodiment utilizes algorithms and signal processing techniques to interpret the capacitance measurements obtained between two or more client devices and/or client suites. The capacitance values are analyzed to determine the relative distance and orientation between the client devices and/or client suites, thereby facilitating the establishment of a commonality measurement. The integration of capacitance elements in the client devices and client suites described herein offers an improved approach to commonality sensing, unlocking improved possibilities for meaningful connections.

In an embodiment, the capacitance measurement may be utilized to determine the commonality between two client devices or client suites and an assessment of the likeness data described above may be utilized to determine the likeness between two client devices or client suites. As a nonlimiting example, a capacitance element may be disposed in the display indicator. In such a nonlimiting example, the capacitance element within the display indicator may act as a “receptor,” wherein the element is adapted to sense commonality of another capacitance element, and wherein the element is configured to relay the capacitance measurement to the client device or suitable component within the client suite. The capacitance element may be suited for determining the presence of other client devices or suites within a moderate range.

In an embodiment, the capacitance embodiment and the capacitance elements thereof may be utilized to produce 3D imaging, wherein said capacitance element(s) are positioned on a client device to capture spatial data. These capacitance elements, as contemplated above, may be configured to detect changes in capacitance influenced by the surrounding environment, allowing for the manifestation of a 3D model of the client suite's surroundings. By analyzing the capacitance data, the system may determine the spatial relationships and proximities between an instant client suite and other objects, including commonality to other client suites equipped with similar capacitance elements. In one embodiment, a user may be equipped with three or more capacitance elements, permitting triangulation mapping of objects within the user/device environment. Yet further, with the addition of artificial intelligence imaging, an accurate and rapidly rendered 3D model may be created. In other embodiments, the system may utilize sonic technology to render the 3D model. The 3D model may define the environment and, accordingly, facilitate a robot's movement and interactions in said environment.

In a further embodiment, the capacitance embodiment may be integrated with the robotic use case contemplated above. As a nonlimiting example, a robot may be equipped with capacitance elements, permitting 3D imaging of the robot's surroundings. In one such embodiment, objects within the robot's known surroundings may include capacitance elements with a known signature, such that the robot equipped with capacitance elements may discern the identity and commonality of said objects.

The development and implementation of capacitance sensing may be based upon both sides (the “receptor” and the “body”) of the measurement capability. For the purposes of this disclosure, the “receptor” may be adapted to measure the capacitance of the “body” to determine a signal strength that relates to the distance between the two entities. The present disclosure may include capacitance sensing utilizing both amplification of receptor sensitivity and specifically configured “body” devices that amplify presence to improve the perceivable range. In a further embodiment, the system may include a specific “resonance” configured to identify such “body” devices.

The capacitance sensing protocols described above allow for usage in both personal physical local usage and robotic physical local usage to determine the commonality of an object. As a nonlimiting example, the capacitance sensing protocols may be configured to determine the “nearness” of an object in a moderate range (e.g., inches to 6 to 8 feet). For the purposes of this disclosure, this procedure is referred to as general capacitance perception.

Referring to the robotic physical local usage embodiment of the capacitance sensing protocol, such a technique allows for the robotic devices to curate a map of their surroundings. Such a map may be augmented with a pier system of signaling, which may then be processed to create a 3D model of the environment. Such a 3D model may either be saved and modified in the client device (e.g., robot) or may be saved in an internal environment (e.g., an intraNet environment) on a central server or a local server accessible by one or more client devices or suites.

The resultant 3D map generated via the mapping protocol discussed above may be a formative element to the robotic physical local usage. By deriving a map of its environment, the robot may be enabled to move about its environment without collision or interference. In a further embodiment, each of the robots or client devices may be programmed with a “right of way” protocol. The 3D map and the perception of the instant client device may be located in said 3D map to guide the instant client device with, what is akin to, electronic vision.

The aforementioned 3D map schema may be utilized with a special capacitance sensing configuration for robotic end-effector manipulation and other motile robotic aspects. The detail and accuracy of an underlying robotic system may be greatly enhanced as a result of the commonality detection methods described herein. As a nonlimiting example, one or more digits of a robotic arm, end-effector, or like device may be suited with one or more capacitance elements. Such a capacitance sensing protocol may allow for the device to be programed to take action (e.g., to pick up a desired item). With each digit having a capacitance element, the signals may be coordinated to generate a locally defined 3D image, that may enable the robotic device to sense an object, approach it, articulate, and interact with said object. Such computer-executable instructions may be directed to the client device through the commonality protocols discussed earlier, for example, via the structure indicated in FIG. 3. In a further embodiment, a plurality of client suites, each utilizing the aforementioned capacitance sensing methods, may exchange information, either with a central unit or across one or more neighboring units.

In any of the embodiments described above, instructions transmitted between any two suitable devices may be instructions previously encoded, for example, via a system administrator. In another embodiment, the instructions may be generated via artificial intelligence or machine learning algorithms. Further, the instructions may be dynamic, such that said instructions change depending on the states or other characteristics of the underlying devices.

Any of the aforementioned embodiments may be configured for operation in a local or private infrastructure. For example, the associated information exchange and process to determine the associated information exchange may be carried out exclusively between two devices, wherein no communication is extended to the Internet, server, or cloud component. In effect, in such an example, the data transferred between two devices is exclusively available via either of the transmitting and/or receive device. Accordingly, the associated information exchange and steps leading up to said associated information exchange may not be retrievable by any centralized server or centralized network. Such an exchange protocol may promote privacy across participating devices, free of the supervision of a server or network administrator. The associated information exchange and the data correlated with the steps leading up to said associated information exchange may be stored locally on one or more of the communicating devices. In such an embodiment, the associated information exchange may be later transmitted to a server or the Internet. Therefore, the system described herein may operate offline.

The system described herein may include the following steps or components. A form may be provided to gather information from the user or the device. Information may be transferred in JSON format to the users or devices. In one embodiment, before or during transmission of signals or data, the devices may be assessed to determine adequate power input and/or battery capacity. The connection of users and/or devices may be manifested by the commonality algorithm described herein. In different embodiments, the commonality algorithm may be common to all users/devices or may be modified for specific users/devices or classes of users/devices. For the purposes of this disclosure, a “session” may commence with the transmission and detection of local devices/users. In such an embodiment, each device may be adapted to transmits, for example, via Bluetooth, the device's JSON packet. Signal strength may be determined based on the time sequence or other related characteristics of transmission and reception.

The commonality matching algorithm may contemplate different criteria, for example, signal strength. The signal strength may be determined and prioritized (e.g., should devices be within a “threshold”). Devices may be above such a threshold; thus, such devices are eligible for determining a “commonality”. In this senecio if the signal strength is within the threshold the received JSON packet may be compared with the onboard JSON packet (e.g., the JSON packet contained within the receiving device) to determine a match.

An example procedure may include:
Field of info:
“Name”
“Assigned USSID”
“CATegory” (Interest or Specialty) with Color Code

| | |
|---|---|
| 1. Artist | WHITE |
| 2. Engineer | BLUE |
| 3. Businessperson | RED |
| 4. Politician/Influencer/Organizer | GREEN |
| 5. Writer/Creator | PURPLE |
| 6. Student | YELLOW |

“ASsociation” Company/Location Base
   1. Central
   2. North
   3. South
   4. East
   5. West
   6. Other
“LT Learn/Teach”: Buy/Sell: Level of Interest
   0. Neutral
   1. Learn
   2. Teach
“JF Juice Factor” priority ranking

In an embodiment, the system may first consider the CAT, second, the AS, and third, the LT.

The following is a depiction of algorithm criteria and match determination:
Should the signal threshold be met. . .
& a match in CAT . . . there is a match;
& a match in AS . . . there is a secondary match;
& a match in LT . . . there is a tertiary match.

After a match, the system may switch transmission to WiFi transmission. At this step, after a match is declared, one or more special packets may be sent between said matched devices. Further, a history of matches may be stored on each device (e.g., including at least the identification information for each device). In a further embodiment, a display array may be created, wherein the display array may cause the indicator device or other suitable component to display, indicate, and/or transmit a certain data object or signal or a certain pattern.

In an embodiment, while a device is in display mode, for a certain period of time, all other transmissions may stop temporarily. However, in a further embodiment, the system may include a check function, wherein if the parties or devices separate the parties or devices will be deemed to no longer be engaged. Moreover, the system may include a button or other means of activation that ends the engagement, wherein such a means is available to one or more of the two parties/devices.

In an embodiment, the indicator may include a segment of multi-LEDs. In one embodiment, the indicator includes eight LEDs or any suitable number of LEDs. The LEDs may display a particular sequence, order, color schema, etc.

In an embodiment, prior to a matched state, all devices may display their CATegory color. As a nonlimiting example, purple LED display may indicate that the user is a “Writer/Creator.” The LED lights may blink, scan, or show any other visible characteristics to indicate a particular CATegory or other variable. The indicator device may also include a name tag and/or a selected quote.

After a prescribed set time or a distancing of the parties or a selection to not engage, the system may reset, wherein history and retained data may be saved and/or transient data may be cleared. After such a procedure, the system may recommence beacon mode.

After a session is completed, a history array may be created and saved, for example, comprising the list of match experiences and associated documentation. Such a history array may be downloadable either locally to the user, to a central database, or both.

The system described herein may utilize independent local devices (e.g., a plurality of client suites) that communicate with one another, for example, embodying server functionality and client functionality. In such an embodiment, each of the plurality of client suits may be adapted to switch roles between a server role and a client role. In an embodiment, each client suite may comprise an independent component configured to act as either the “server” or the “client,” wherein said independent component can be paired to client devices (e.g., smartphones, smartwatches, and the like). In various embodiments, such devices may be “loaded” and/or programed either from a central database or from independent user control devices. As described herein, to ensure privacy at certain stages of the process, such devices may download data locally to minimize intervention from third-party entities or external networks.

In an embodiment, the system may include a centrally controlled mesh web of devices, for example, a regionally controlled mesh web of devices. In various embodiments, the system may be configured to load information and instructions and a device may follow the exact instructions and/or the instructions may be reconfigured during execution based on the status of the device or condition thereof. For example, a user may be enabled to direct a device to carry out particular instructions or download a particular data point or set.

Although the description herein contemplates algorithms to control interactivity, the system described herein may be adapted for use with any suitable third-party system. For example, the commonality matching protocol described above may be configured for use in any suitable network, with any compatible platform, and/or with any suitable device(s). In further embodiments, other parties may provide control algorithms and matching algorithms. Similarly, in further embodiments, other parties may inject customized or personalized instructions or information to be transmitted via the system described herein.

Any of the aspects described herein, for example, matching components, instruction transmission, and the like, may include AI or machine learning elements. The systems and methods described herein may be implemented in various use cases, including, but not limited to, meet and greets; research campuses; extended research organizations and/or social organizations; hospital information exchange (e.g., corporate, military); games, video games, and toys; flying car buoy systems (e.g., drone navigation technology, such as systems for defining a lane and flight path); robotic perception of objects in their environment (e.g., gained by the “triangulation” of devices that then create a 3D image map); a communication device between users to indicate location and communication (e.g., military or combat applications); a subsystem of preexisting capacitance touch devices (e.g., recognizing and/or displaying patterns to indicate a response); and a security access system (e.g., permitting badge holders prescribed access).

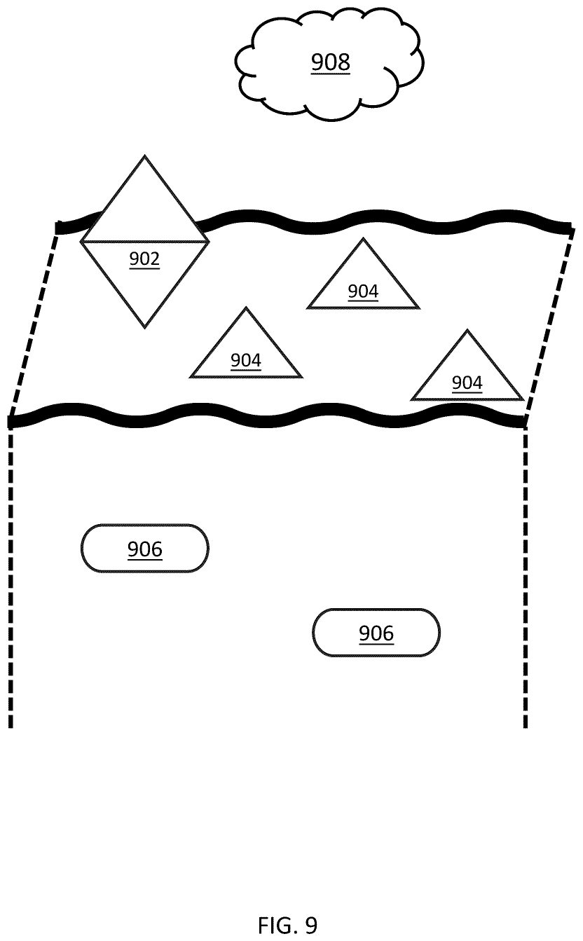

FIG. 9 is an example embodiment, utilizing the client suite for aquatic navigation and information retrieval. In such an embodiment, the system may include one or more control communicators or regional buoys 902, one or more surface float communicators 904, and/or one or more submerged communicators 906. Each of the aforementioned components (the one or more control communicators or regional buoys 902, the one or more surface float communicators 904, and/or the one or more submerged communicators 906) may include a client suite or operative components of a client suite, such that each of the aforementioned components may transmit communications. As a nonlimiting example, the one or more control communicators or regional buoys 902, the one or more surface float communicators 904, and/or the one or more submerged communicators 906 may be configured with sensors capable of extracting information from the medium in which they are disposed (e.g., water temperature, flow rate, flow direction, tidal information, salinity, mineral composition, density, or other related metrics). Thus, as a nonlimiting example, the one or more regional buoys 902 may be in informatic communication with a subset of the one or more float communicators 904 and/or the one or more submerged communicators 906. Such an informatic communication may be fixed, wherein a fixed subset of the one or more float communicators 904 and/or the one or more submerged communicators 906 are wirelessly tethered to a particular regional buoy 902. Thus, in this instance of informatic communication, a particular regional buoy 902 may be in a fixed position along with the wirelessly tethered float communicators 902 and/or submerged communicators 906. In such an embodiment, the aforementioned components may positionally fixed (e.g., physically tethered to a riverbed or seabed or mechanically kept in an absolute position via actuated motors and propellers). In another embodiment, the regional buoy 902 may be in a fixed position, wherein the regional buoy 902 enters wireless communication with the float communicators 904 and/or the submerged communicators 906 as the float communicators 904 and/or the submerged communicators 906 move within a certain distance of the regional buoy 902 (e.g., via river flow, tidal changes, currents or other motion inducing conditions). In another embodiment, the aforementioned principle applies, yet the regional buoy 902 may also have freedom of motion, for example, floating without a physical tether. In the example embodiment shown in FIG. 9, the various components may be in informatic communication with a GPS module, the Internet, a server, or another network component. In one embodiment, the regional buoy 902 may be in informatic communication with a GPS module, the Internet, a server, or another network component, while the float communicators 904 and/or the submerged communicators 906 remain in communication with one another and/or a regional buoy 902. Any of the regional buoys 902, the float communicators 904, and/or the submerged communicators 906 may be in communication with network 908. Network 908 may embody any of the networks or means of wireless communication described herein.

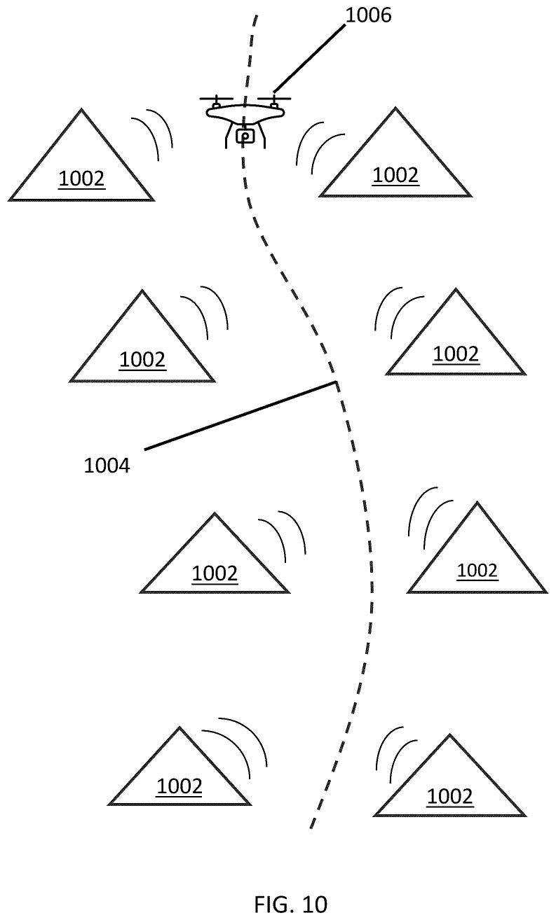

FIG. 10 is an example embodiment, utilizing the client suite for air navigation and aviation drone communication. In such an embodiment, the system may include one or more aerial buoys 1002, a flight path 1004, and/or an aerial drone 1006. Each of the aforementioned components (the one or more aerial buoys 1002 and/or the aerial drone 1006) may include a client suite or operative components of a client suite, such that each of the aforementioned components may transmit communications. As a nonlimiting example, the one or more aerial buoys 1002 and/or aerial drone 1006 may be configured with sensors capable of extracting information from the medium in which they are disposed (e.g., air temperature, air flow rate, air flow direction, wind information, moisture content, pollutant composition, air density, or other related metrics). Thus, as a nonlimiting example, the aerial buoys 1002 may be in informatic communication with the aerial drone 1006. The aerial buoys 1002 may transmit communication to the aerial drone 1006, for example, transmitting flight coordinates of the flight path 1004. Thus, in this instance of informatic communication, one or more aerial buoys 1002 in a certain proximity to the aerial drone 1006 may transmit the flight path 1004 coordinates to the aerial drone 1006. Accordingly, as the aerial drone 1006 moves in and out of proximity with a given aerial buoy 1002, communication may be initiated. Each of the aerial buoys 1002 may be positioned in fixed positions such that an aerial drone 1006 traveling on the flight path 1004, will always be within communicative distance with one or more of the aerial buoys 1002. The aerial drone 1006 may enter wireless communication with the aerial buoys 1002 as the aerial drone 1006 moves within a certain distance of said aerial buoys 1002 (e.g., via undesired movement from strong winds or via desired movement of the aerial drone 1006 traveling on the flight path 1004). In an embodiment, the aerial buoys 1002 may be physically tethered to the ground, for example, via poles cemented to the earth, via chains or rope, or via other physical tethering means. In an embodiment, the aerial buoys 1002 may be equipped with propulsion means, allowing such buoys 1002 to remain in the airspace without physical tethering. In another embodiment, the aforementioned principle applies, yet the aerial buoys 1002 may also have freedom of motion, for example, floating without a physical tether. In the example embodiment shown in FIG. 10, the various components may be in informatic communication with a GPS module, the Internet, a server, or another network component.

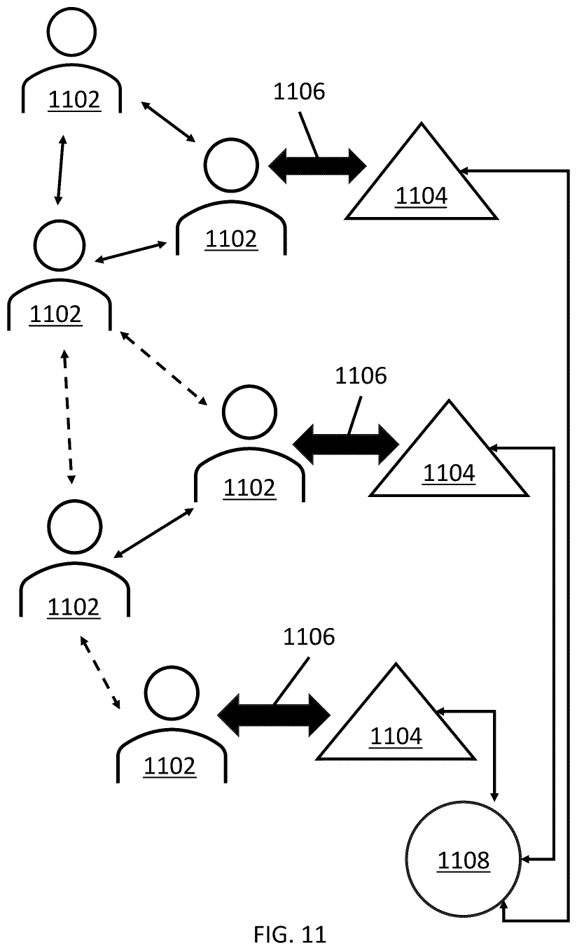

FIG. 11 is an example embodiment, utilizing the client suite for group interaction and subgroup communication. Such a system may be utilized for group interactions, such as research or trade conferences, corporate conferences, entertainment venues or interactive game venues, and other related interactions. Referring to FIG. 11, solid double arrowed lines may symbolize a likeness exchange, for example, as dictated by the likeness measurement and assessment described throughout the instant disclosure; broken double arrowed lines may symbolize an instance where a likeness exchange was not instigated, wherein the likeness exchange threshold was not met; and the thick solid double arrowed lines may symbolize a subgroup connections to a subgroup module 1104. Thus, each of the personal modules 1102, for example, including the client suite and/or significant components of the client suite (e.g., worn in a badge embodiment or utilizing a smart phone) may signal and/or connect based on likeness, as defined throughout this instant disclosure, wherein each of the subgroups of personal modules 1102 (formed by communicating personal modules 1102) may initiate a subgroup signal 1106 with one or more subgroup modules 1104. The subgroup modules 1104 may be independent devices configured to transmit communication to members of a given subgroup. In a further embodiment, a master administrator 1108 (e.g., a device accessible by a human administrator or a device programmed to operate as an administrator) may be in informatic communication with each of the subgroup modules 1104. As a nonlimiting example, the master administrator 1108 may direct the communication between the subgroup module 1104 and the underlying subgroup members. In the example embodiment shown in FIG. 11, the various components may be in informatic communication with a GPS module, the Internet, a server, or another network component.

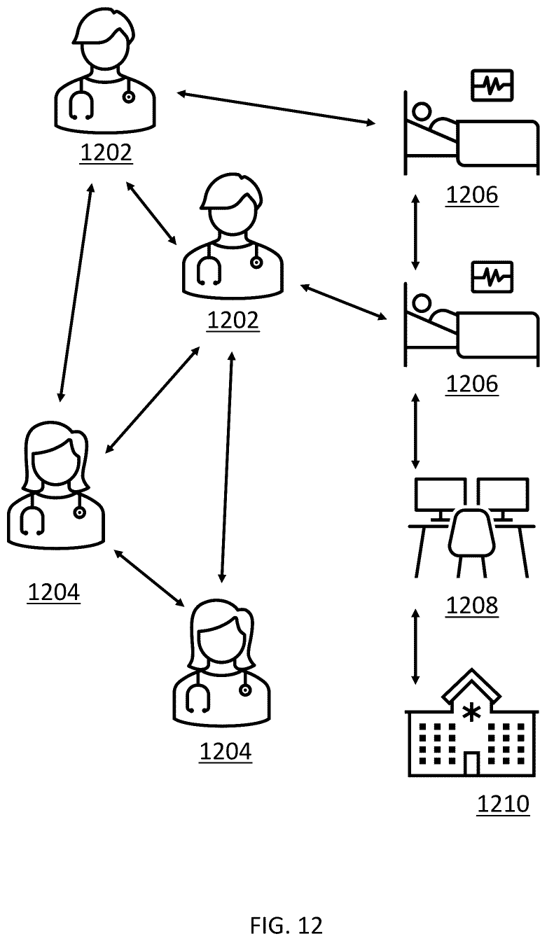

FIG. 12 is an example embodiment, utilizing the client suite for a hospital network communication system. Such a system may include one or more primary care provider (PCP) modules 1202, one or more support provider modules 1204, one or more patient modules 1206, one or more provider station modules 1206, and/or one or more administrative modules 1210. Each of the one or more primary care provider (PCP) modules 1202, the one or more support provider modules 1204, the one or more patient modules 1206, the one or more provider station modules 1206, and/or the one or more administrative modules 1210 may include a client suite and/or operative components of the client suite. Referring to FIG. 12, each of the modules 1202-1210 may be in communication with one another. As a nonlimiting example, the patient modules 1206 may be configured to communicate information relating a patient's health state or information about the medical devices in use with the patient (e.g., diagnostics, blood pressure, body temperature, remaining volume of intravenous fluids, etc.). Thus, the provider station module 1208 may be configured to analyze the patient modules 1206 and may determine when intervention from one of the PCP modules 1202 and/or support provider modules 1204 is warranted. Thus, the provider station module 1208 may direct the patient modules 1206 to signal for assistance from one of the PCP modules 1202 and/or the support provider modules 1204. Further, in an embodiment, the patient modules 1206 may be configured to retrieve assistance from the one or more PCP modules 1202, wherein the PCP modules 1202 are configured to request assistance from one or more support provider modules 1204 as needed based on the underlying request from the patient module 1206 or provider station module 1208. As a nonlimiting example, the provider station module 1208, while continuously or regularly reviewing health diagnostics of the patient modules 1206, may determine that one of the patient modules 1206 is attached to a patient experiencing cardiac arrest. The provider station module 1208 may generate a request for the patient module 1206 to broadcast, wherein the request includes a required number or identity of PCP modules 1202 and/or support provider modules 1204. The request may be transmitted to the correct PCP module 1202, wherein that PCP module 1202 may further request assistance from the correct number or identity of support provider modules 1204. The administrative module 1210 may be configured to direct operations between all other modules and/or generate and keep record of rules and policies. Thus, the administrative module 1210 may generate and/or create the rules which dictate the required identities, quantities, and other characteristics of each PCP module 1202 and/or support provider module 1204 as needed for a given medical event.

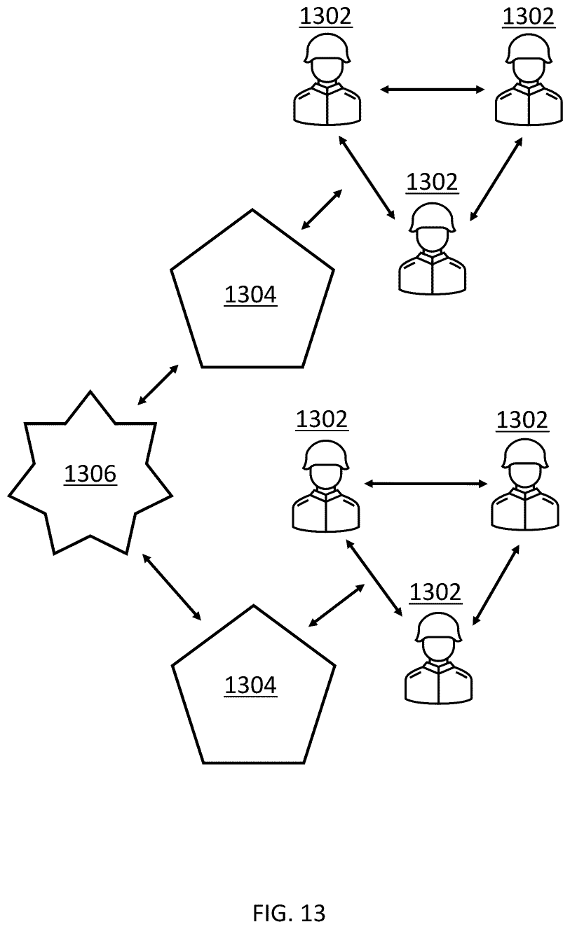

FIG. 13 is an example embodiment, utilizing the client suite for military operations and communication. In such a system, one or more troop modules 1302 may substantiate a unit, wherein the one or more troop modules 1302 in a given unit are in informatic communication with a unit subnetwork 1304, and wherein each of the unit subnetworks 1304 are in communication with the command module 1306. In such an embodiment, the command module 1306 may be configured to deliver instructions or other information to a unit via communication with that unit's unit subnetwork 1304, wherein the unit subnetwork 1304 may disseminate such information across the troop modules 1302.

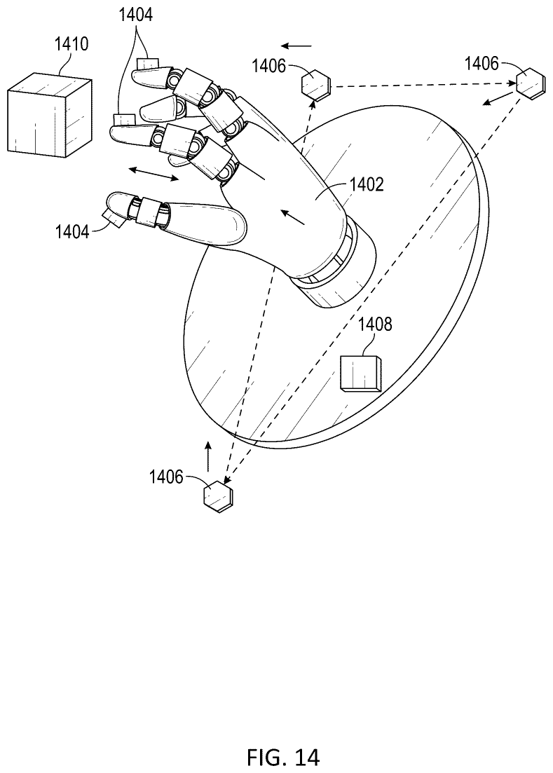

FIG. 14 is an example embodiment, utilizing the client suite for robotic hand manipulation and imaging. In such an embodiment, the system may be configured for general positioning, fingering sensing, and overall capacitance. For example, such a system may allow for robotic devices to curate a map of their surroundings. Such a map may be augmented with a plurality of sensors or other devices (e.g., sonar) disposed on the end of each digit of a hand, which may then be processed to create a 3D model of the environment. The resultant 3D map generated via the mapping protocol discussed above may be a formative element to the robotic physical local usage. Each of the digit devices 1404 may be disposed on the robotic member 1402 and may be in informatic communication with a central system processor 1408, wherein the central system processor 1408 is configured to generate the 3D modeled environment, analyze objects within the 3D modeled environment, and provide instructions or objectives to each of the digit devices 1404. The system may include mapping modules 1406, wherein each of the mapping modules 1406 is in communication with at least the central system processor 1408. The mapping modules 1406 may also be configured to determine the relative and/or absolute position of one or more of the digit devices 1404. Accordingly, the digit devices 1404 may be determine spatial characteristics of a target object 1410, for example, by relating information to the central system processor 1408. Additional features of such an example embodiment are contemplated above in reference to the 3D mapping functionality.

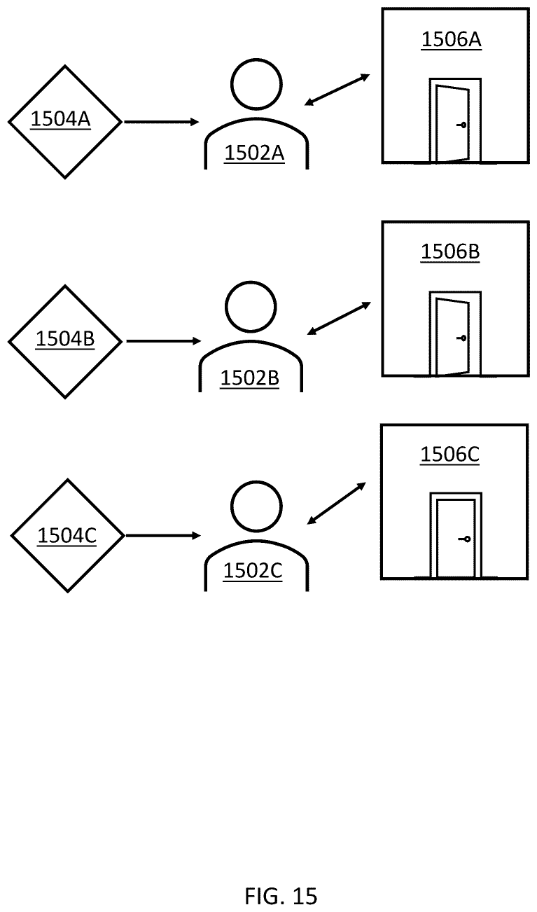

FIG. 15 is an example embodiment, utilizing the client suite for security access. The system may include one or more identity modules 1502A/1502B/1502C, one or more key clocks 1504A/1504B/1054C, and one or more area modules 1506A/1506B/1506C. Each of the area modules 1506A/1506B/1506C may be configured to actuate a given security functionality. For example, such area modules 1506A/1506B/1506C may be configured to unlock a door based on permissions received from one of the identity modules 1502A/1502B/1502C and/or key clocks 1504A/1504B/1504C. Each of the key clocks 1504A/1504B/1504C may be wirelessly tethered to a given identity module 1502A/1502B/1502C. Thus, the permissions stored within the area modules 1506A/1506B/1506C may be configured to analyze whether a given key clock 1504A/1504B/1504C or identity module 1502A/1502B/1502C has sufficient security clearance for a given area.

In an embodiment, the system comprises a memory storing user information associated with each of a plurality of clients; a processor configured to: evaluate, via a commonality evaluator, whether two or more of the plurality of clients surpass a commonality threshold, the two or more of the plurality of clients comprising at least a first client and a second client, wherein the commonality threshold is a summation of any one of a physical commonality threshold, a virtual commonality threshold, and a social systematic commonality threshold, wherein the physical commonality threshold is defined by reception of a signal, wherein the virtual commonality threshold is defined by reception of an electronic correspondence in a computing environment, and wherein the social systematic commonality threshold is defined by one or more connections between the plurality of clients; determine, via a likeness evaluator, whether the two or more of the plurality of clients share one or more common features or characteristics; determine whether at least one of the two or more of the plurality of clients surpasses an information sharing inclination metric; determine whether the two or more of the plurality of clients surpass a likeness threshold, the likeness threshold based on at least the one or more common features or characteristics and the information sharing inclination metric; record, if the two or more of the plurality of clients surpass the commonality threshold and the likeness threshold, an associated information exchange between the two or more of the plurality of clients; a plurality of client devices comprising at least a first client device and a second client device, the first client device associated with the first client, the first client device configured to receive at least the associated information exchange from a processor, the first client device configured to transmit the associated information exchange to at least the second client device associated with the second client; an indicator device in informatic communication with at least one of the plurality of client devices, the indicator device configured to output an indication upon reception of the associated information exchange from a transmitting client device, the indicator device comprising at least one of a vibrational motor, a speaker, a light indicator, a display screen, and a signal transmitter; wherein the output of the indication comprises actuation of one of the vibrational motor, the speaker, and the light indicator, and wherein the indicator device is an attachable component adapted to reversibly affix to at least one of the two or more of the plurality of clients.

In an embodiment, the one or more common interests are discernable from client-specific data collected from the plurality of clients, wherein the client-specific data was derived from one of: a questionnaire, an external information source, or an artificial intelligence model output, wherein the artificial intelligence model output is output from an artificial intelligence model configured to generate generative client-specific data for one or more of the plurality of clients and/or a prescribed instruction set.

In an embodiment, the system further comprises a mesh communication system comprising a plurality of nodes, the plurality of nodes comprising one or more of the plurality of client devices and/or one or more of the indicator devices in informatic communication with at least one of the plurality of client devices, wherein a relativistic commonality of each of the plurality of nodes is based on Global Positioning System (GPS) information, a network of positioning sensors, a signal strength of transmission or reception of one or more of the plurality of nodes, a capacitance power metric, a sonographic metric, and/or signal refraction metric between two or more of the plurality of nodes.

In an embodiment, the computing environment comprises a virtual convention, and/or a machine convention.

In an embodiment, the one or more connections between the plurality of clients is further defined by commonality of intellectual or common characters in organizations.

In an embodiment, the first client device configured to transmit a notification to one or more of the plurality of clients, wherein the notification actuates the indicator device, wherein the notification comprises an opt-in option and an opt-out option, wherein the opt-in option is configured to connect the first client device to the one or more of the plurality of clients, and wherein the opt-out option ceases the notification.

In an embodiment, ethe indicator device of the first client is configured to transmit an introduction request from the first client to the second client, wherein, upon transmission of the introduction request, a mirror of the introduction request generates on the display indicator of the second client and the introduction request generates on the display indicator of the first client, wherein the introduction request comprises an identifying characteristic of the second client and the mirror of the introduction request comprises an identifying characteristic of the first client.

In an embodiment, acceptance of the introduction request transmits a “wink” to the first client and denial of the introduction request transmits a “frown” to the first client.

In an embodiment, the processor may be configured to facilitate transfer of information between the first client and the second client upon the associated information exchange, wherein the memory is configured to maintain a history of said information, wherein the associated information exchange and transferred information is stored locally on the first client device and the second client device, and wherein the associated information exchange may be accessible via an authentication credential.

In an embodiment, the processor may be configured to transmit an event request to the first client and the second client based on the associated information exchange.

The present disclosure may provide a system for a transfer of information based upon either a commonality or a prescribed procedure of instructions comprising: a plurality of client suites, each of the plurality of client suites correlated to one of a plurality of parties, the plurality of client devices comprising at least a first party client device and a second party client device, the first party client device associated with the first party, the first party client device configured to receive at least an associated information exchange from the server, the first party client device configured to transmit the associated information exchange to at least the second party client device associated with the second party; a display indicator in informatic communication with at least the first party client suites, the display indicator configured to output an indication upon reception of the associated information exchange from the first party client device, the display indicator comprising an annunciator selected from the group comprising a vibrational motor, a speaker, a light element, and a picture display element, wherein the output of the indication comprises actuation of said annunciator, and wherein the display indictor is an attachable accessory component; a server comprising a memory storing device information associated with each of the plurality of parties and the plurality of client suites, the server further comprising a server processor configured to facilitate an operation, the operation comprising a “Connectivity of Kind” program instructions, execution of the “Connectivity of Kind” program instructions causing the processor to: determine whether the two or more of the plurality of parties share one or more common interests, wherein the one or more common interests exist between the two or more of the plurality of parties and/or a social organization having a connection to at least one of the two or more of the plurality of parties; determine whether at least one of the two or more of the plurality of parties surpasses an information sharing inclination metric; determine whether the two or more of the plurality of parties surpass a likeness threshold, the likeness threshold based on at least the one or more common interests and the information sharing inclination metric; and record, if the two or more of the plurality of parties surpass the likeness threshold, the associated information exchange between the two or more of the plurality of parties.

In an embodiment, the execution of the “Connectivity of Kind” program instructions further causing the processor to: evaluate, via a commonality evaluator, whether two or more of the plurality of parties surpass a commonality threshold, the two or more of the plurality of parties comprising at least a first party and a second party, wherein the commonality threshold is a summation of a physical commonality threshold, a virtual commonality threshold, and a social systematic commonality threshold, wherein the physical commonality threshold is defined by reception of a signal, wherein the signal is: (1) transmitted between the two or more of the plurality of parties and/or a prescribed terminal; and/or (2) generated via a positioning device; wherein the virtual commonality threshold is defined by reception of an electronic correspondence in an analytical communications environment or in the realm of a virtual environment, and/or wherein the social systematic commonality threshold is defined by one or more connections between the plurality of parties.

In an embodiment, the signal is not transmitted between the two or more of the plurality of parties, and wherein the signal is transmitted between the two or more of the plurality of parties and the prescribed terminal.

In an embodiment, the one or more common interests are discernable from party-specific data collected from the plurality of parties, wherein the party-specific data was derived from one of: a questionnaire, an external information source, or an artificial intelligence model output, wherein the artificial intelligence model output is output from an artificial intelligence model configured to generate generative party-specific data for one or more of the plurality of parties.

In an embodiment, the system may further comprise a mesh communication system comprising a plurality of nodes, the plurality of nodes comprising one or more of the plurality of client devices and/or one or more of the display indicators in informatic communication with at least one of the plurality of client devices, wherein a relativistic commonality of each of the plurality of nodes is based on Global Positioning System (GPS) information, a network of positioning sensors, a signal strength of transmission or reception of one or more of the plurality of nodes, and/or a capacitance power metric between two or more of the plurality of nodes.

In an embodiment, the transfer of information between the plurality of client devices is facilitated by a first wireless technology and a second wireless technology.

In an embodiment, the transfer of information is initiated by the first wireless technology, and wherein an exchange of packets is conducted by the second wireless technology.

In an embodiment, the first wireless technology is a patterned identifying signal transmission comprising information encoded in said signal or an attached data packet.

In an embodiment, the first wireless technology is a Bluetooth beacon and the second wireless technology is a local wifi, wherein the first wireless technology is configured as a beacon and the second wireless technology is configured as a means of information exchange.

In an embodiment, the exchange is actuated when the packets meet or are larger than a predetermined size.

In an embodiment, the computing environment comprises one or more virtual conventions, and/or one or more machine conventions.

In an embodiment, the one or more connections between the plurality of parties is further defined by commonality of intellectual or common characters in organizations.

In an embodiment, the first party client device configured to transmit a notification to one or more of the plurality of parties, wherein the notification actuates the indicator device, wherein the notification comprises an opt-in option and an opt-out option, wherein the opt-in option is configured to connect the first party client device to the one or more of the plurality parties, and wherein the opt-out option ceases the notification.

In an embodiment, the display indicator of the first party is configured to transmit an introduction request from the first party to the second party, wherein, upon transmission of the introduction request, a mirror of the introduction request generates on the indicator device of the second party and the introduction request generates on the indicator device of the first party, wherein the introduction request comprises an identifying characteristic of the second party and the mirror of the introduction request comprises an identifying characteristic of the first party.

In an embodiment, the identifying characteristic comprises one of an icon associated with said party, a sound associated with said party, and/or a vibration associated with said party.

In an embodiment, acceptance of the introduction request transmits a “wink” to the first party and denial of the introduction request transmits a “frown” to the first party.

In an embodiment, acceptance of the introduction request initiates the transfer of information, wherein the introduction request comprises exchange of information and said transfer of information is one of automated or subject to choice, and wherein said information if historically noted for later utilization by an artificial intelligence aspect.

In an embodiment, the processor is configured to facilitate transfer of information between the first party and the second party upon the associated information exchange, wherein the memory is configured to maintain a history of said information, wherein the associated information exchange and transferred information is stored locally on the first party client device and the second party client device, wherein the associated information exchange may be accessible via an authentication credential, and wherein said local information is stored on a local device.

In an embodiment, the authentication credential is limited to the party associated with said client device.

In an embodiment, the processor is configured to facilitate transfer of information between the first party and the second party upon the associated information exchange, wherein the memory is configured to maintain a history of said information, wherein the associated information exchange and transferred information is stored in the server, and wherein the associated information exchange may be accessible via an authentication credential.

In an embodiment, the processor is configured to facilitate transfer of information between the first party and the second party upon the associated information exchange, wherein the memory is configured to maintain a history of said information, wherein the associated information exchange and transferred information is stored in the server if a privacy option has been declines, wherein the associated information exchange and transferred information is stored locally on the first party client device and the second party client device if the privacy option has been selected, and wherein the associated information exchange may be accessible on a local device, a regional server, or a cloud server, via an authentication credential.

In an embodiment, the processor is configured to transmit an event request to the first party and the second party based on the associated information exchange.

In an embodiment, the event request comprises a meeting location, a meeting time, and a meeting environment, wherein the meeting environment is selected from the group of physical and virtual.

The present disclosure may provide for a system comprising a plurality of client devices comprising at least a first client device and a second client device, the first client device comprising a first client device display, a first client device processor and a first client device memory comprising a first client device instructions, which when executed by the first client device processor causes to first client device to: transmit, if one or more conditions are in commonality across the first client device and the second client device, a request to the second client device; and the second client device comprising a second client device display, a second client device processor and a second client device memory comprising a second client device instructions, which when executed by the second client device processor causes to second client device to: receive, from the first client device, the request; extract, from the request, a first client device identifier; and displaying, via the second client device display, the first client device identifier.

The present disclosure may provide for a system comprising a plurality of client devices comprising at least a first client device and a second client device, the first client device comprising a first client device display, a first client device processor and a first client device memory comprising a first client device instructions, which when executed by the first client device processor causes to first client device to: transmit a request to the second client device; and the second client device comprising a second client device display, a second client device processor and a second client device memory comprising a second client device instructions, which when executed by the second client device processor causes to second client device to: receive, from the first client device, the request; extract, from the request, if one or more conditions are in commonality across the first client device and the second client device, a first client device identifier; and displaying, via the second client device display, the first client device identifier.

Aspects of the present disclosure relate to a system including: a plurality of independent micro communication devices, each of the plurality of independent micro communication devices including: a signal indicator configured to determine a range of other independent micro communication devices within the plurality of independent micro communication devices; a location monitor in communication with the signal indicator; a microprocessor in communication with a memory, the signal indicator, and the location monitor, the microprocessor configured to emit a beacon signal via a first wireless technology, the microprocessor configured to generate an initial connection between two or more of the plurality of independent micro communication devices, the microprocessor configured to exchange data with the two or more of the plurality of independent micro communication devices substantiating the initial connection via either a primary or second wireless technology, wherein the beacon signal and the first wireless technology are configured for transmission of data packets, wherein, after the initial connection is formed, each of the independent micro communication devices substantiating the initial connection may be transitioned to the second wireless technology, wherein the second wireless technology is configured for transmission of larger data packets than the first wireless technology, wherein the large data packets include one or more instructions; and an indicator device configured to display a nature of the initial connection; wherein the microprocessor is configured to transmit an individual identification code for the micro communication device; wherein the individual identification code includes group membership information; wherein the microprocessor is configured to determine the identification, range, and location of at least one of the plurality of independent micro communication devices via the first wireless technology or the second wireless technology; wherein the microprocessor is configured with the ability to communicate with at least one of the plurality of independent micro communication devices independently of centrally administered controlling instructions; wherein the microprocessor can be configured with the ability to communicate with at least one of the plurality of independent micro communication devices through one or more internet cloud-based services; wherein the microprocessor can be configured with the ability to be remotely administered; and wherein the microprocessor is configured to record a log of events and communications with at least one of the plurality of independent micro communication devices; and wherein the microprocessor can be configured with the ability to interact with users through a virtual environment.

Aspects of the present disclosure relate to a system, wherein each of the plurality of independent micro communication devices are configured to store preliminary data, the preliminary data including identity characteristics, wherein the preliminary data is derived from one of: a form completed by an individual, information provided by a central source, or information gathered, via artificial intelligence, from one or more available sources, or one or more of the plurality of micro communication devices; and wherein each of the plurality of independent micro communication devices is configured such that the storing of the preliminary data is directed by instructions.

Aspects of the present disclosure relate to a system, wherein each of the plurality of independent micro communication devices within a predetermined range are configured to communicate with each other to facilitate data transmission, positioning, and robotic control; and wherein each of the plurality of independent micro communication devices further may include a clock; wherein the microprocessor is configurable to synchronize the clock with at least one of the plurality of independent micro communication devices within a predetermined range.

Aspects of the present disclosure relate to a system, wherein the data transmission between each of the plurality of independent micro communication devices within a predetermined range is stored in a data structure contained in the memory; wherein the data structure is in communication with one or more artificial intelligence components; wherein microprocessor is configured to upload or download the data structure or a portion thereof to other devices directly, without requiring an internet connection; wherein the microprocessor can access the data structure privately; and wherein each of the independent micro communication device may be individually controlled.

Aspects of the present disclosure relate to a system, wherein the nature of the initial connection can be indicated on each of the independent micro communication devices substantiating the initial connection, wherein subsequent to the substantiated initial connection, each of the devices will exchange identity information; and wherein the nature of the initial connection includes (i) an identity and (ii) a status of each of the independent micro communication devices substantiating the initial connection; wherein the indication is visual, auditory, vibrational, or a transmitted electronic signal; and wherein the indication conveys information including whether one of the independent micro communication devices matched a portion of its identity information with another of the independent micro communication devices.

Aspects of the present disclosure relate to a system, wherein each of the independent micro communication devices substantiating the initial connection are configured with status information and adapted to promote a direct data exchange, wherein the direct data exchange includes exchange of at least one of: artificial intelligence-derived information, preprogramed data exchange, or a personal interaction; and wherein the data exchanged may be stored in memory and archived in a history of exchanged data.

Aspects of the present disclosure relate to a system, wherein the one or more instructions are dynamically uploaded or are dynamic and controlled in real-time by the user, the independent administrator, a system administrator, or any combination thereof.

Aspects of the present disclosure relate to a system, the system including a positioning module configured to spatially synchronize and calibrate the plurality of independent micro communication devices in a physical environment; and wherein the microprocessor is configured to communicate with at least one of the plurality of micro communication devices in the physical environment to receive information from sensors, send information to displays, receive information from a robot, or send information to a robot; and wherein the microprocessor is configured to create a three dimensional model for guidance.

Aspects of the present disclosure relate to a system, the system including a positioning module configured to spatially synchronize and calibrate the plurality of independent micro communication devices in a physical or virtual environment; and to share data with one or more of the plurality of independent micro communication devices with matching group information.

Aspects of the present disclosure relate to a system including: a plurality of independent micro communication devices, each of the plurality of independent micro communication devices configured to communicate and connect with the plurality of independent micro communication devices and display a nature of the connection, wherein each of the plurality of independent micro communication devices are controlled by at least one of a central control and a regional control, wherein each of the plurality of independent micro communication devices is programmed with an identity, wherein the identity is one of self-propagated and centrally controlled, and wherein the central control has access to all components of the plurality of independent micro communication devices.

Aspects of the present disclosure relate to a system, wherein each of the plurality of independent micro communication devices are preloaded with preliminary data, wherein the preliminary data is derived from one of: a form completed by an individual, information provided by a central source, or information gathered, via artificial intelligence, from one or more available sources.

Aspects of the present disclosure relate to a system, wherein each of the plurality of independent micro communication devices within a predetermined range are configured to communicate with each other to facilitate data transmission, positioning, and robotic control.

Aspects of the present disclosure relate to a system, wherein the data transmission between each of the plurality of independent micro communication devices within the predetermined range is stored in a database, and wherein the database is in communication with an artificial intelligence component.

Aspects of the present disclosure relate to a system, wherein the nature of the connection is indicated on each of the independent micro communication devices substantiating the connection, wherein the nature of the connection includes the identity or type of each of the independent micro communication devices substantiating the connection.

Aspects of the present disclosure relate to a system, wherein each of the independent micro communication devices substantiating the initial connection are configured to engage in direct exchange of data, wherein the data directly exchanged includes at least one of: artificial intelligence-derived information, preprogramed data exchange, or a personal interaction.

Aspects of the present disclosure relate to a system, wherein one of the central control and the regional control curate one or more instructions sets and transmit said instruction sets to the plurality of independent micro communication device, wherein the one or more instructions sets are fixed and pre-uploaded, or are dynamic and controlled in real-time by a system administrator, or a combination thereof.

Aspects of the present disclosure relate to a system, the system including a positioning module configured to spatially synchronize and calibrate the plurality of independent micro communication devices in a physical environment; and wherein the microprocessor is configured to communicate with at least one of the plurality of micro communication devices in the physical environment to receive information from sensors, send information to displays, receive information from a robot, or send information to a robot; and wherein the microprocessor is configured to create a three dimensional model for guidance.

Aspects of the present disclosure relate to a system, the system including a positioning module configured spatially synchronize and calibrate the plurality of independent micro communication devices in a physical or virtual environment; and to share data with one or more of the plurality of independent micro communication devices with matching group information.

Aspects of the present disclosure relate to a system, the system including a positioning module configured to spatially synchronize and calibrate the plurality of independent micro communication devices in a physical or virtual environment.

Aspects of the present disclosure relate to a system including: a plurality of independent micro communication devices, each of the plurality of independent micro communication devices configured to communicate and connect with each other and display a nature of their connectivity, wherein the plurality of independent micro communication devices are programmed for use within an entertainment environment, wherein the entertainment environment is one of a real world and a virtual world, and wherein the plurality of independent micro communication devices are configured to exchange information and media amongst one or more of the plurality of independent micro communication devices.

Aspects of the present disclosure relate to a system, wherein the entertainment environment is a gaming environment, wherein the gaming environment includes cyber representation within a client device, wherein the cyber representation and the gaming environment are based on the location of the client device within the gaming environment, wherein the location of the gaming environment is based on an overlay of a virtual map over a real map; wherein the gaming environment mediates interaction between the participants; wherein the independent micro communication devices are configured to exchange data with other devices in real time or in a store and forward configuration; and wherein the independent micro communication devices are configured to record a log of events and communications with one or more other devices in the plurality of independent micro communication devices.

Aspects of the present disclosure relate to a system, wherein each of the plurality of independent micro communication devices is configured to: (i) augment displays or indicators, (ii) induce sounds, and (iii) induce vibrational sensations in one or more of the plurality of independent micro communication devices, and wherein each of the plurality of independent micro communication devices is further configured to: (i) determine a position of one or more of the plurality of independent micro communication devices (ii) derive information via one or more sensors, wherein the one or more sensors are disposed within at least one of the plurality of independent micro communication devices, (iii) sense its own position in either a physical or virtual environment, and (iv) exchange interactive signals with another of the plurality of independent micro communication devices.

These and other aspects, features, and advantages of the present invention will become more readily apparent from the following drawings and the detailed description of the preferred embodiments.

The workflow described herein may be executed and/or used in connection with any suitable machine learning, artificial intelligence, and/or neural network methods. For example, the machine learning models may be one or more classifier and/or neural network. However, any types of models may be utilized, including regression models, reinforcement learning models, vector machines, clustering models, decision trees, random forest models, Bayesian models, and/or Gaussian mixture models. In addition to machine learning models, any suitable statistical models and/or rule-based models may be used.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the claims.

What is claimed is:

1. A system comprising:
a plurality of independent micro communication devices, each of the plurality of independent micro communication devices comprising:
a signal indicator configured to determine a range of other independent micro communication devices within the plurality of independent micro communication devices;
a location monitor in communication with the signal indicator;
a microprocessor in communication with a memory, the signal indicator, and the location monitor, the microprocessor configured to emit a beacon signal via a first wireless technology, the microprocessor configured to generate an initial connection between two or more of the plurality of independent micro communication devices, the microprocessor configured to exchange data with the two or more of the plurality of independent micro communication devices substantiating the initial connection via either a primary or second wireless technology,
wherein the beacon signal and the first wireless technology are configured for transmission of data packets,
wherein, after the initial connection is formed, each of the independent micro communication devices substantiating the initial connection may be transitioned to the second wireless technology,
wherein the second wireless technology is configured for transmission of larger data packets than the first wireless technology,
wherein the large data packets comprise one or more instructions; and
an indicator device configured to display a nature of the initial connection;
wherein the microprocessor is configured to transmit an individual identification code for the micro communication device; wherein the individual identification code includes group membership information;
wherein the microprocessor is configured to determine the identification, range, and location of at least one of the plurality of independent micro communication devices via the first wireless technology or the second wireless technology;
wherein the microprocessor is configured with the ability to communicate with at least one of the plurality of independent micro communication devices independently of centrally administered controlling instructions;
wherein the microprocessor can be configured with the ability to communicate with at least one of the plurality of independent micro communication devices through one or more internet cloud-based services;
wherein the microprocessor can be configured with the ability to be remotely administered; and
wherein the microprocessor is configured to record a log of events and communications with at least one of the plurality of independent micro communication devices; and
wherein the microprocessor can be configured with the ability to interact with users through a virtual environment.

2. The system of claim 1, wherein each of the plurality of independent micro communication devices are configured to store preliminary data, the preliminary data comprising identity characteristics, wherein the preliminary data is derived from one of: a form completed by an individual, information provided by a central source, or information gathered, via artificial intelligence, from one or more available sources, or one or more of the plurality of micro communication devices; and wherein each of the plurality of independent micro communication devices is configured such that the storing of the preliminary data is directed by instructions.

3. The system of claim 1, wherein each of the plurality of independent micro communication devices within a predetermined range are configured to communicate with each other to facilitate data transmission, positioning, and robotic control; and wherein each of the plurality of independent micro communication devices further may comprise a clock; wherein the microprocessor is configurable to synchronize the clock with at least one of the plurality of independent micro communication devices within a predetermined range.

4. The system of claim 3, wherein the data transmission between each of the plurality of independent micro communication devices within a predetermined range is stored in a data structure contained in the memory; wherein the data structure is in communication with one or more artificial intelligence components; wherein microprocessor is configured to upload or download the data structure or a portion thereof to other devices directly, without requiring an internet connection; wherein the microprocessor can access the data structure privately; and
wherein each of the independent micro communication device may be individually controlled.

5. The system of claim 1, wherein the nature of the initial connection can be indicated on each of the independent micro communication devices substantiating the initial connection, wherein subsequent to the substantiated initial connection, each of the devices will exchange identity information; and wherein the nature of the initial connection comprises (i) an identity and (ii) a status of each of the independent micro communication devices substantiating the initial connection; wherein the indication is visual, auditory, vibrational, or a transmitted electronic signal; and wherein the indication conveys information comprising whether one of the independent micro communication devices matched a portion of its identity information with another of the independent micro communication devices.

6. The system of claim 1, wherein each of the independent micro communication devices substantiating the initial connection are configured with status information and adapted to promote a direct data exchange, wherein the direct data exchange comprises exchange of at least one of: artificial intelligence-derived information, preprogramed data exchange, or a personal interaction; and wherein the data exchanged may be stored in memory and archived in a history of exchanged data.

7. The system of claim 1, wherein the one or more instructions are dynamically uploaded or are dynamic and controlled in real-time by the user, the independent administrator, a system administrator, or any combination thereof.

8. The system of claim 1, the system comprising a positioning module configured to spatially synchronize and calibrate the plurality of independent micro communication devices in a physical environment; and wherein the microprocessor is configured to communicate with at least one of the plurality of micro communication devices in the physical environment to receive information from sensors, send information to displays, receive information from a robot, or send information to a robot; and wherein the microprocessor is configured to create a three dimensional model for guidance.

9. The system of claim 1, the system comprising a positioning module configured to spatially synchronize and calibrate the plurality of independent micro communication devices in a physical or virtual environment; and to share data with one or more of the plurality of independent micro communication devices with matching group information.

10. A system comprising:
a plurality of independent micro communication devices, each of the plurality of independent micro communication devices configured to communicate and connect with the plurality of independent micro communication devices and display a nature of the connection,
wherein each of the plurality of independent micro communication devices are controlled by at least one of a central control and a regional control,
wherein each of the plurality of independent micro communication devices is programmed with an identity,
wherein the identity is one of self-propagated and centrally controlled, and
wherein the central control has access to all components of the plurality of independent micro communication devices.

11. The system of claim 10, wherein each of the plurality of independent micro communication devices are preloaded with preliminary data, wherein the preliminary data is derived from one of:
a form completed by an individual, information provided by a central source, or information gathered, via artificial intelligence, from one or more available sources.

12. The system of claim 10, wherein each of the plurality of independent micro communication devices within a predetermined range are configured to communicate with each other to facilitate data transmission, positioning, and robotic control.

13. The system of claim 12, wherein the data transmission between each of the plurality of independent micro communication devices within the predetermined range is stored in a database, and wherein the database is in communication with an artificial intelligence component.

14. The system of claim 10, wherein the nature of the connection is indicated on each of the independent micro communication devices substantiating the connection, wherein the nature of the connection comprises the identity or type of each of the independent micro communication devices substantiating the connection.

15. The system of claim 10, wherein each of the independent micro communication devices substantiating the initial connection are configured to engage in direct exchange of data, wherein the data directly exchanged comprises at least one of: artificial intelligence-derived information, preprogramed data exchange, or a personal interaction.

16. The system of claim 10, wherein one of the central control and the regional control curate one or more instructions sets and transmit said instruction sets to the plurality of independent micro communication device, wherein the one or more instructions sets are fixed and pre-uploaded, or are dynamic and controlled in real-time by a system administrator, or a combination thereof.

17. The system of claim 10, the system comprising a positioning module configured to spatially synchronize and calibrate the plurality of independent micro communication devices in a physical environment; and wherein the microprocessor is configured to communicate with at least one of the plurality of micro communication devices in the physical environment to receive information from sensors, send information to displays, receive information from a robot, or send information to a robot; and wherein the microprocessor is configured to create a three dimensional model for guidance.

18. The system of claim 10, the system comprising a positioning module configured spatially synchronize and calibrate the plurality of independent micro communication devices in a physical or virtual environment; and to share data with one or more of the plurality of independent micro communication devices with matching group information.

19. The system of claim 10, the system comprising a positioning module configured to spatially synchronize and calibrate the plurality of independent micro communication devices in a physical or virtual environment.

20. A system comprising:
a plurality of independent micro communication devices, each of the plurality of independent micro communication devices configured to communicate and connect with each other and display a nature of their connectivity,
wherein the plurality of independent micro communication devices are programmed for use within an entertainment environment,
wherein the entertainment environment is one of a real world and a virtual world, and
wherein the plurality of independent micro communication devices are configured to exchange information and media amongst one or more of the plurality of independent micro communication devices.

21. The system of claim 20, wherein the entertainment environment is a gaming environment, wherein the gaming environment comprises cyber representation within a client device, wherein the cyber representation and the gaming environment are based on the location of the client device within the gaming environment, wherein the location of the gaming environment is based on an overlay of a virtual map over a real map; wherein the gaming environment mediates interaction between the participants; wherein the independent micro communication devices are configured to exchange data with other devices in real time or in a store and forward configuration; and wherein the independent micro communication devices are configured to record a log of events and communications with one or more other devices in the plurality of independent micro communication devices.

22. The system of claim 20, wherein each of the plurality of independent micro communication devices is configured to: (i) augment displays or indicators, (ii) induce sounds, and (iii) induce vibrational sensations in one or more of the plurality of independent micro communication devices, and wherein each of the plurality of independent micro communication devices is further configured to: (i) determine a position of one or more of the plurality of independent micro communication devices (ii) derive information via one or more sensors, wherein the one or more sensors are disposed within at least one of the plurality of independent micro communication devices, (iii) sense its own position in either a physical or virtual environment, and (iv) exchange interactive signals with another of the plurality of independent micro communication devices.
